(19) United States
(12) Patent Application Publication
(10) Pub. No.: US 2026/0289083 A1
(43) Pub. Date: Sep. 24, 2026

(54) SYSTEM

(71) Applicant: SoftBank Group Corp., Tokyo (JP)

(72) Inventor: Shengzhe LI, Tokyo (JP)

(73) Assignee: SoftBank Group Corp., Tokyo (JP)

(21) Appl. No.: 19/566,993

(22) Filed: Mar. 14, 2026

(30) Foreign Application Priority Data
Mar. 19, 2025 (JP) 2025-045068

(51) Int. Cl. G06F 40/166

(52) U.S. Cl. CPC G06F 40/166

(57) ABSTRACT

A system includes a processor that is configured to receive information in a bullet-point format as an input, analyze the information by using natural language processing techniques, and generate a prompt sentence for instructing a generative artificial intelligence model to generate a business document, automatically check and correct the generated business document by using an algorithm for detecting typographical errors and grammatical errors, and analyze a user emotion and adjust content of the business document based on the user emotion.

### CROSS-REFERENCE TO RELATED APPLICATION

This application is based on and claims priority under 35 USC 119 from Japanese Patent Application No. 2025-045068 filed on Mar. 19, 2025, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Conventional techniques for generating business documents using generative artificial intelligence models typically require users to manually formulate detailed prompts and to perform extensive post-editing. In particular, when a user provides only concise bullet-point information, conventional systems are not capable of automatically converting such information into effective prompts that can direct a generative artificial intelligence model to produce a coherent and stylistically appropriate business document. As a result, users must invest significant time and effort in prompt engineering and in reviewing and correcting the generated document, including correction of typographical and grammatical errors. Furthermore, conventional systems generally do not take into consideration the emotional state or preferences of the user, and therefore cannot flexibly adjust the tone and style of the generated business document in accordance with the user's emotional state or business context. This leads to a risk that the generated document may not align with the user's intended nuance or communication style, thereby reducing business effectiveness and user satisfaction. Accordingly, there is a need for a system that can, based on simple bullet-point input, automatically generate effective prompts, perform automatic quality checks and corrections on the generated business document, and adjust the content, tone, and style of the document in accordance with the user's emotional state and user-defined criteria.

### SUMMARY

In order to solve the above-described problems, the present invention provides a system comprising a processor, wherein the processor is configured to receive information in a bullet-point format as an input, analyze the information by using natural language processing techniques, and generate a prompt sentence for instructing a generative artificial intelligence model to generate a business document. The processor is further configured to automatically check and correct the generated business document by using an algorithm for detecting typographical errors and grammatical errors, thereby reducing the burden on the user for manual proofreading and correction. In addition, the processor is configured to analyze a user emotion and adjust content of the business document based on the user emotion, so that the generated document reflects the user's emotional state and intended nuance. The processor is also configured to refer to criteria set by the user and to adjust the prompt for instructing the generative artificial intelligence model to check and correct the content of the business document, thereby enabling flexible control of the confirmation and correction process in accordance with user-defined standards. Moreover, the processor is configured to evaluate an emotional state of the user and to generate a prompt for instructing an adjustment of a tone and a style of the business document based on a result of the evaluation, thereby enabling automatic adaptation of the document's tone and style to the user's emotional condition and contextual requirements. Through these means, the system according to the present invention significantly reduces the time and effort required for creating, correcting, and tailoring business documents while improving consistency, quality, and alignment with the user's intent.

The term “processor” refers to any hardware, firmware, or combination of hardware and software, including one or more CPUs, GPUs, or specialized circuits, that executes instructions to perform the functions described in the claims.

The term “information in a bullet-point format” refers to input data provided as a plurality of short textual items, each representing a discrete point or element, such as a list of features, conditions, or topics, typically separated by line breaks, bullets, or similar delimiters.
The term “natural language processing techniques” refers to computational methods and algorithms for analyzing, interpreting, and transforming human language text, including but not limited to tokenization, parsing, part-of-speech tagging, entity recognition, semantic analysis, and intent detection.
The term “prompt sentence” refers to a text string or set of text strings generated by the processor and provided as an instruction or input to a generative artificial intelligence model to control or guide the content, structure, tone, or style of an output to be generated by the model.
The term “generative artificial intelligence model” refers to a machine-learned model, such as a large language model or similar generative model, that is configured to generate text of a business document in response to an input prompt.
The term “business document” refers to any text intended for business or professional communication, including but not limited to business emails, proposals, notices, reports, offers, contracts, or announcements.
The term “algorithm for detecting typographical errors and grammatical errors” refers to a set of computational rules, models, or procedures that analyze text to identify and optionally correct misspellings, incorrect word forms, punctuation errors, syntactic inconsistencies, or other deviations from a target language's grammar.
The term “automatically check and correct” refers to processing performed by the processor without requiring explicit manual editing of each error by the user, wherein the processor detects errors in a text and modifies the text to remove or reduce such errors.
The term “user emotion” refers to an emotional state or affective condition of a user, such as satisfaction, frustration, confidence, anxiety, or formality preference, which is detected or inferred by the processor from user input, behavior, or other signals.
The term “adjust content of the business document based on the user emotion” refers to modifying at least part of the wording, emphasis, level of detail, or selection of information in the business document such that the resulting content better reflects or aligns with the detected user emotion.
The term “criteria set by a user” refers to configuration information, rules, or parameters explicitly provided or selected by the user, including but not limited to target tone, style, politeness level, formality level, length constraints, quality thresholds, or review policies to be applied to generation, checking, or correction of the business document.
The term “adjust the prompt for instructing the generative artificial intelligence model to check and correct the content of the business document” refers to modifying all or part of the prompt sentence so that the generative artificial intelligence model performs checking and correction operations according to the criteria set by the user, such as specifying desired tone, style, or error sensitivity.
The term “emotional state of the user” refers to a quantified or categorized representation of the user emotion, such as a discrete label (for example, “formal”, “relaxed”, or “urgent”) or a value on one or more emotional dimensions determined by the processor.
The term “generate a prompt for instructing an adjustment of a tone and a style of the business document” refers to creating one or more prompt sentences that direct the generative artificial intelligence model to revise or generate the business document so that its tone (for example, formal, informal, polite, assertive) and style (for example, concise, detailed, marketing-oriented) are modified in accordance with a determined emotional state or other conditions.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

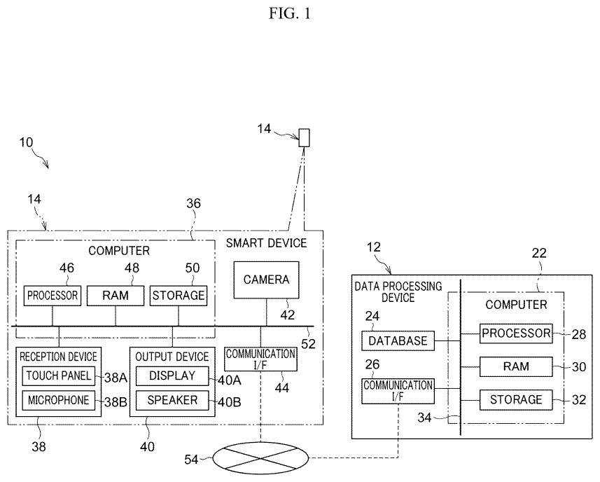

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

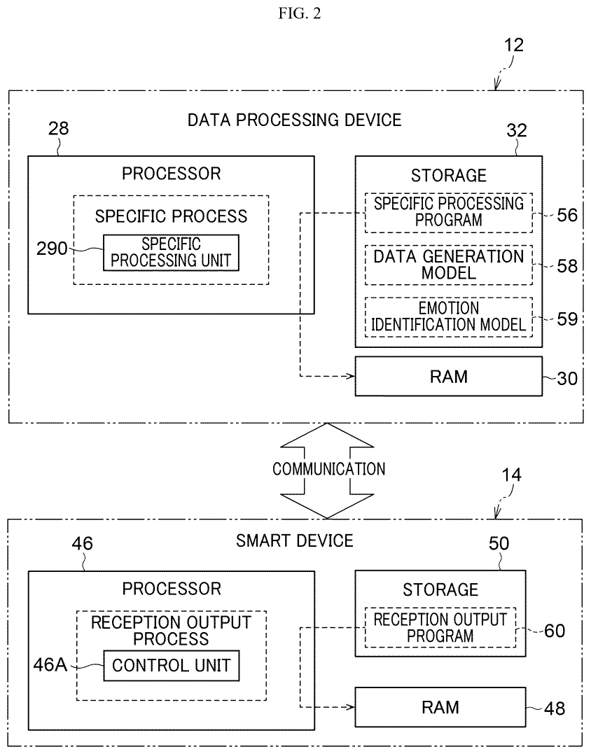

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional computer-implemented document generation systems that utilize machine learning or generative AI models generally focus only on converting input text into output text in a one-shot manner. Such systems typically accept free-form or template-based input, forward the input directly as a prompt to a remote generative AI service, and return a generated document to a client terminal without performing deeper structural control or adaptive post-processing. As a result, several technical problems arise in the field of computer technology.

First, existing systems lack structured control over how bullet-point information is converted into a prompt sentence and how that prompt sentence constrains the behavior of a generative AI model. Without explicit, programmatic construction and dynamic adjustment of prompt sentences based on internal data structures and evaluation standards, the generative AI model often produces outputs that are inconsistent in structure, completeness, or style. This leads to variability in machine-generated texts and requires extensive manual correction at the client side, increasing processing time and resource consumption and reducing the overall reliability of the document generation pipeline.
Second, typical systems do not incorporate an integrated, automated verification and correction stage that operates on the output of a generative AI model using deterministic text processing algorithms and language rule data. In many implementations, spelling and grammar checking are either absent or performed in a loosely coupled manner at the application layer on the client device. This separation prevents efficient server-side optimization of text quality, and forces each client device to redundantly perform similar verification tasks, resulting in duplicated computation, inconsistent correction logic, and inefficient use of network and processing resources.
Third, conventional systems generally do not exploit user behavioral signals and emotion-related information as first-class inputs to the server-side control logic of the document generation process. User emotion is, at best, inferred implicitly at the front end or ignored altogether. No integrated mechanism is provided for estimating a user's emotional state from low-level behavioral data (such as input speed, correction frequency, and expression selection patterns) and for using that state, together with user-defined evaluation standards, to algorithmically adjust the tone, style, and detail level of the generative AI prompt sentence and/or the generated document text. Consequently, the generated documents may mismatch the user's situational intent or desired communication style, which requires further manual editing and reduces the practical efficiency of the system.
Fourth, existing architectures typically lack a centralized server-side mechanism for enforcing user-specific evaluation standards, expression rules, and prohibitions across the entire lifecycle of prompt generation, generative AI interaction, and document post-processing. Without such a mechanism, each client or each application module may implement its own ad-hoc rules, leading to inconsistent enforcement of constraints, increased likelihood of non-compliant or undesired content, and difficulty in maintaining or updating standards in a scalable manner.
Accordingly, there is a need for a computer-implemented system that improves the way a server constructs, controls, and post-processes prompt sentences and generated documents, by: (i) receiving and modeling bullet-point information in structured internal data, (ii) algorithmically constructing and dynamically adjusting prompt sentences for a generative AI model based on evaluation standards and user emotion, (iii) performing integrated, server-side verification and correction of the generated document using language rule data, and (iv) coordinating these processes so as to improve determinism, consistency, and efficiency of the document generation pipeline as a whole. The technical problem to be solved is to improve the functioning of the server and its cooperation with a generative AI model and client terminals, so that the system produces high-quality, contextually appropriate business documents with reduced manual intervention and more efficient utilization of computational and network resources.

The specific processing by the specific processing unit 290 of the data processing device 12 in Example 1 is realized by the following means.

The present invention provides a server comprising a processor configured to receive information in a bullet-point format via a terminal and a communication network, to store the received information in one or more structured data formats, and to acquire the information as input data; to apply natural language processing algorithms to the input data so as to analyze meanings and mutual relationships of phrases, to determine a type, constituent elements, and logical structure of a target document, and to concatenate the bullet-point information with template instruction text to generate a prompt sentence as generation instruction information; to generate generation request data including the prompt sentence and to transmit the generation request data to an external generative information processing apparatus that executes a generative AI model, and to receive, from the external generative information processing apparatus, business document data produced by inference processing of the generative AI model; to apply text-processing algorithms and language rule data to the business document data so as to detect typographical and grammatical errors, to automatically generate correction proposals, and to incorporate the correction proposals into the business document data; to analyze emotion estimation information including user operation history and expression selection information, to estimate an emotional state of the user, and to determine adjustment conditions indicating tone, style, and level of detail based on the emotional state and preset user conditions; to modify at least one of the prompt sentence and the business document data so as to reflect the adjustment conditions and to further change the content and structure of the prompt sentence based on user-specified evaluation standards, expression standards, and prohibitions; and to transmit the resulting business document data to the terminal as output data in a format displayable by the terminal. This enables the server to implement an improved document generation pipeline in which the construction and adjustment of the prompt sentence, the interaction with the generative AI model, and the verification and emotion-aware adjustment of the generated text are centrally controlled and optimized, thereby improving the technical functioning of the computer system by increasing determinism and consistency of outputs, reducing redundant client-side processing, and enhancing the efficiency and reliability of generating context-appropriate business documents.

The term “terminal” refers to an information processing device, such as a personal computer, smartphone, tablet, or similar computing apparatus, that provides a user interface for inputting, transmitting, receiving, and displaying data to and from a server via a communication network.

The term “communication network” refers to a wired or wireless data communication infrastructure, such as a local area network, a wide area network, or a public packet-switched network, that enables data exchange between the terminal, the server, and an external information processing apparatus.
The term “bullet-point format” refers to a data format in which information items are listed as discrete elements, each element representing a separate item of content, typically structured as an ordered or unordered list within a text or data structure.
The term “data structure” refers to an organized form of data representation in memory, such as an array, list, map, or similar construct, in which elements of information are stored and managed by a processor for subsequent processing.
The term “input data” refers to data that is received by the server from a terminal or other source, and that is used as a basis for subsequent processing, including analysis, generation of prompt sentences, and generation of document data.
The term “natural language processing” refers to a class of computational techniques and algorithms that allow a processor to analyze, interpret, and manipulate text expressed in a human language, including operations such as tokenization, parsing, semantic analysis, and discourse analysis.
The term “prompt sentence” refers to a text sequence that includes an instruction or request to a generative AI model, optionally combined with input information such as bullet-point items, and that is used as generation instruction information to control behavior of the generative AI model.
The term “generation instruction information” refers to information, including a prompt sentence and associated parameters, that specifies how a generative AI model is to perform a generation process, such as the type, style, or structure of a document to be generated.
The term “template instruction text” refers to a predefined text segment that expresses a generic instruction or request for generation of content, and that is combined with variable input information, such as bullet-point data, to form a prompt sentence.
The term “generation request data” refers to data transmitted from the server to an external information processing apparatus, the data including at least a prompt sentence and optional control parameters, and serving as a request for the generative AI model to perform an inference process.
The term “external generative information processing apparatus” refers to an information processing system, distinct from the server and terminal, that executes one or more generative AI models and performs inference processing based on received generation request data.
The term “generative AI model” refers to a machine-learned model, such as a neural network-based language model, configured to generate text or other structured output in response to input data including prompt sentences.
The term “inference process” refers to processing performed by a trained generative AI model in which the model receives input data, applies its learned parameters, and outputs generated data, such as a text document, without further training updates.
The term “business document data” refers to digital text or associated metadata representing a document intended for business-related communication, such as correspondence, notifications, proposals, or reports, generated or processed within the system.
The term “text-processing algorithm” refers to a computational procedure executed by a processor for analyzing or transforming text data, including operations such as spelling checking, grammar checking, tokenization, or text normalization.
The term “language rule data” refers to data representing syntactic, grammatical, or orthographic rules of a natural language, which data is used by a processor to evaluate correctness of text and to generate or apply corrections.
The term “correction proposal” refers to information indicating a suggested modification of text data, such as replacement, insertion, or deletion of characters or words, intended to correct detected errors or improve linguistic quality.
The term “emotion estimation information” refers to data used to estimate a user's emotional state, the data including, for example, user operation history, expression selection history, and other behavioral or interaction information.
The term “operation history” refers to recorded data describing user interactions with a user interface, including at least operation types, operation order, timestamps, and frequencies of specific input or editing actions.
The term “expression selection information” refers to data representing selections or preferences of the user for particular words, phrases, or styles of expression, as observed through user input and editing behavior.
The term “emotional state” refers to an estimated state of a user's emotion, such as a degree of urgency, politeness, positivity, or negativity, derived by analyzing emotion estimation information using one or more algorithms.
The term “preset user conditions” refers to configuration data specifying user-specific preferences or constraints, the configuration having been registered in advance, and including items such as desired tone, style, level of detail, and compliance rules.
The term “adjustment conditions” refers to information indicating how tone, writing style, and level of detail of a prompt sentence or document are to be changed, the information being derived from at least an estimated emotional state and preset user conditions.
The term “evaluation standards” refers to predefined criteria for assessing content quality, including requirements related to accuracy, completeness, consistency, or compliance, that are referenced when controlling generation or modification of a document.
The term “expression standards” refers to predefined rules or preferences governing choice of words, degree of formality, politeness level, and stylistic patterns that should be reflected in generated or modified documents.
The term “prohibitions” refers to predefined constraints indicating expressions, terms, or content types that are not permitted to appear in generated or modified documents.
The term “behavioral information” refers to data describing how a user interacts with a terminal or application, including, for example, input speed, input order, correction frequency, and patterns of expression selection.
The term “tone information” refers to data describing target tonal characteristics of a document, such as formality, politeness, directness, or emotional intensity, that are to be applied when generating or modifying text.
The term “writing-style information” refers to data describing stylistic characteristics of text, including sentence length, structural patterns, and use of particular types of expressions, that are to be applied when generating or modifying text.
The term “output data” refers to data generated or processed by the server and transmitted to a terminal, the data being in a format suitable for display, storage, or further processing at the terminal.
The term “displayable format” refers to a data format, such as plain text, markup text, or structured document data, that can be rendered visually or otherwise presented to a user by a terminal.

In one embodiment, the server is implemented as an information processing apparatus comprising at least one processor, a main memory, a non-volatile storage device, and a network interface. The server runs a server-side operating system such as a general-purpose server operating system and executes an application program implemented, for example, using a web application framework such as a JavaScript runtime with a web framework or a Python runtime with a web framework. The server communicates with one or more terminals via a communication network such as the Internet, a local area network, or a wireless network.

The terminal is implemented as a computing device such as a smartphone, tablet computer, notebook computer, or desktop computer. The terminal includes a processor, a memory, a display, an input device such as a keyboard or touch panel, and a network communication module such as a Wi-Fi or cellular communication module. The terminal runs a client-side application, for example a web browser such as a general-purpose browser or a native mobile application, and provides user interface screens for inputting and displaying text.
The user operates the terminal to input information in a bullet-point format. The terminal converts key operations or touch operations into character strings using input processing functions provided by an operating system such as a mobile operating system or a desktop operating system. The terminal then structures the input bullet-point items as an ordered list of text strings in a local memory region. Each bullet point is stored, for example, as an element of an array or list data structure, enabling the terminal to maintain the order and identity of each item.
The terminal transmits the structured bullet-point information to the server through the communication network. The terminal uses an HTTP client mechanism such as a browser-embedded HTTP stack or a client library to send a request message to the server, the request message including the bullet-point items as text data. The bullet-point items are encoded, for example, in UTF-8 and encapsulated in a data structure such as a JSON object or other structured payload.
The server receives the request at a network endpoint managed by a web server such as a general-purpose HTTP server and an application server environment. The server parses the request, decodes the text data, and stores the bullet-point items in a server-side memory as an internal data structure, for example, as an array of string objects or as records in an in-memory table. The server may optionally write the received bullet-point items to a persistent storage system such as a relational database management system, using structured query language operations through an object-relational mapping library.
The server applies natural language processing algorithms to the bullet-point items. In one embodiment, the server tokenizes each bullet-point string into tokens, using a tokenization module implemented as part of a natural language processing library. The server further performs part-of-speech tagging and dependency parsing on each bullet-point string, so that the server can extract syntactic roles and relations between words. The server then computes semantic representations such as vector embeddings for each bullet point using a pre-trained word or sentence embedding model. The server stores these embeddings in a vector data structure, and uses vector similarity calculations to determine mutual relationships among bullet points, for example to detect topical similarity, temporal order, or logical dependency. The server determines a type, constituent elements, and logical structure of a target business document on the basis of the syntactic and semantic analysis results. For example, the server classifies the intended document type as a business email, a report, or a notice by applying a classifier implemented as a shallow neural network or a support vector machine, which takes the aggregated embeddings of the bullet points as input. The server then maps semantic roles detected in the bullet points (such as product name, schedule, discount condition, and campaign duration) to abstract slots of a document template. These operations use predefined rule sets and mapping tables stored in the server's storage device.
The server constructs a prompt sentence as generation instruction information for a generative AI model. The server holds template instruction texts in a template storage module; each template is a generic instruction phrase corresponding to a document type, tone, and style. The server concatenates an appropriate template instruction text with the bullet-point items, converting each bullet point into a textual line introduced by a list marker, and forms a prompt sentence as a continuous text block. The server may include additional meta-instructions regarding language, tone, and target audience in the prompt sentence.
For instance, the server can generate a prompt sentence such as:
“Based on the following bullet points, please create a formal business email in English that we can send to corporate clients:
Launch of new product X on April 1st
Introductory 20% discount for first three months
Limited-time promotional campaign with free onboarding support”
   In another example, the server can generate a prompt sentence such as:
“Using the bullet points below, generate a professional business proposal in English for potential partners:
Expansion into the European market
Partnership opportunities with local distributors
Expected sales growth over the next two years”
   The server encapsulates the prompt sentence in generation request data to be provided to an external generative information processing apparatus. The generation request data includes not only the prompt sentence but also control parameters such as the target model identifier, maximum number of output tokens, temperature (controlling randomness), and top-k or top-p sampling parameters. These parameters are stored in a configuration data structure and are applied to the request so as to influence output determinism, diversity, and length.
   The server transmits the generation request data to the external generative information processing apparatus via the communication network. The external apparatus hosts a generative AI model implemented as a deep neural network, such as a transformer-based language model. The generative AI model has a multi-layer architecture composed of an input embedding layer, multiple self-attention layers, feed-forward layers, and a final projection layer to a vocabulary space. The model parameters (weights) have been pre-trained using large-scale text corpora by minimizing a loss function such as cross-entropy between predicted tokens and ground-truth tokens. During the pre-training phase, a training algorithm such as stochastic gradient descent or a variant thereof is used to iteratively update weights based on gradients computed by backpropagation.
   The external apparatus receives the prompt sentence as a sequence of tokens, transforms each token into an embedding vector using an embedding matrix, and processes the sequence through self-attention mechanisms that compute attention scores among tokens. Each layer generates intermediate representations that capture syntactic and semantic dependencies across the prompt. The model then predicts a next token at each step based on a probability distribution over the vocabulary, and repeatedly generates tokens until a stopping condition such as reaching a maximum token count or encountering an end-of-sequence token is met. The resulting sequence of tokens is decoded back into text, forming business document data. The server receives the business document data from the external generative apparatus as a text string or structured response. The server parses the response and extracts the generated document text, storing it in a memory buffer. The server then applies deterministic text-processing algorithms and language rule data to this text. For example, the server runs a spelling checker that compares each token against a lexicon database and suggests candidate corrections based on edit distance algorithms. The server also runs a grammar checking module that uses a combination of rule-based grammar patterns and statistical language models to detect subject-verb agreement issues, incorrect tense usage, and punctuation errors. The server formulates correction proposals as structured data entries indicating a position in the text, the detected issue, and a candidate correction string.
   The server automatically applies at least some of the correction proposals according to a priority rule set. The server may, for instance, apply high-confidence corrections those where a language model assigns a probability above a threshold to the document text, by modifying the text buffer at the indicated positions. Less certain corrections may be flagged and stored as metadata for optional later presentation. By centralizing this verification and correction at the server, the system avoids repeated, inconsistent checking at each terminal and ensures that a single, coherent rule set underlies all corrections.
   The server collects and analyzes emotion estimation information relating to the user. The terminal transmits operation history data including input speed (keystrokes per unit time), input order, and correction frequency (number of text modifications per segment) as part of interaction logs. The terminal also transmits expression selection information, such as which suggested phrases from a phrase-completion module were chosen or rejected by the user. The server stores this information in a time-series data structure and aggregates it over a session or multiple sessions.
   The server estimates the emotional state of the user by applying an emotion estimation model to the behavioral information. In one embodiment, the server uses a feature extraction module to compute numerical features such as average input latency per character, variance of latency, ratio of deletions to insertions, and frequency of strong or polite expressions selected by the user. These features are provided to a classifier model such as a small neural network or a decision tree that has been trained on labeled data indicating emotional states (e.g., “calm,” “hurried,” “formal,” “informal”). The classifier outputs an emotional state label and associated confidence scores, which are stored as emotion state data associated with the current document generation context.
   The server maintains preset user conditions representing user preferences for tone, formality, and detail level, as well as evaluation standards, expression standards, and prohibitions. These are stored as configuration records in a database and include, for example, numeric scales for desired formality, flags indicating whether certain phrases or topics are prohibited, and style profiles indicating preferred sentence length and level of explicitness. The server retrieves these conditions and combines them with the estimated emotional state to derive adjustment conditions. The adjustment conditions include explicit parameters such as target politeness level, permitted range of sentence length, emphasis degree for certain content categories, and allowed or disallowed phrasing patterns.
   The server applies the adjustment conditions to at least one of the prompt sentence and the generated business document data. In one mode, the server modifies a subsequent prompt sentence for the generative AI model. For example, if the emotional state is determined to be “hurried” and the user preferences indicate a concise style, the server inserts control phrases like “Write the email briefly and directly” into the prompt sentence. If the emotional state is more formal and the user requires strict politeness, the server adds instructions such as “Use a very polite and formal tone.” In another mode, the server post-processes the generated business document data by applying a rewriting module that uses a ruleset and optional smaller-scale language models to adjust phrases to match the desired tone and style, for example by replacing overly casual expressions with more formal equivalents or by shortening overly long sentences.
   The server transmits the final, verified, and adjusted business document data to the terminal in a displayable format. The server encapsulates the text and optional metadata such as suggested corrections, emotion state labels, and applied adjustment conditions, and sends an HTTP response message to the terminal. The terminal parses the response and renders the business document in a user interface component, such as a rich text editor implemented using client-side script and markup. The terminal may highlight corrected regions or emotion-based modifications visually so that the user can understand the system's adjustments.
   This configuration improves computer technology in several ways. By structuring bullet-point information in explicit data structures and performing server-side natural language analysis and document structure inference, the server reduces the size and complexity of data transmitted to the external generative apparatus, leading to lower communication load and more efficient use of network resources. By centrally constructing and dynamically adjusting prompt sentences based on evaluation standards and emotion-derived adjustment conditions, the server reduces variability of generative outputs and improves determinism of the generation process, thereby simplifying downstream processing and storage.
   Furthermore, by integrating a deterministic text-verification and correction pipeline using language rule data, the server decreases the number of errors in generated documents and offloads processing from terminals, which would otherwise perform duplicative checking. This centralized verification enables optimized algorithms and shared caches on the server, improving processing speed for large numbers of documents. The emotion estimation mechanism uses detailed behavioral features rather than explicit emotional input, enabling the server to adapt tone and style automatically using a non-conventional, data-driven rule set that differs from simple manual editing; this leads to more appropriate documents with less manual correction and improves the overall throughput of the system.
   The generative AI model employed by the external apparatus is not treated as a black box in the architecture. The server explicitly controls model behavior using tuned parameters such as temperature and maximum token counts, and uses prompt sentence structure and content derived from structured analysis and emotion-aware conditions. Because the generative AI model has a transformer architecture trained with a specific loss function and optimized via gradient descent, its internal representations and attention mechanisms are leveraged in a controlled way by the server's prompt design and parameter settings to achieve higher accuracy and consistency in structured business documents than would be obtained with naive or static prompts.
   Alternative embodiments are possible. In another embodiment, the server hosts a generative AI model locally rather than relying on an external apparatus, in which case the server directly performs tokenization, embedding lookup, attention computation, and token generation on local hardware such as general-purpose processors combined with graphics processing units or specialized accelerators. In another variation, the server uses a hybrid approach in which a smaller, locally hosted generative model performs style and tone adjustments on text initially generated by a larger remote model, thereby reducing network usage while preserving quality. In another embodiment, the emotion estimation model can be implemented as a recurrent neural network or transformer-based classifier trained with supervised learning on labeled behavioral sequences, with a custom loss function that penalizes misclassification of emotional states that are particularly relevant to business communication.
   In yet another embodiment, the server can store multiple template instruction texts and style profiles, and select appropriate combinations based on application domain (for example marketing, legal, or technical communication) and user role. The server can also maintain historical logs of bullet-point sets, prompt sentences, adjustment conditions, and final outputs, and use this historical data to further refine its evaluation standards and emotion estimation thresholds. Such historical analysis can be performed offline using batch processing and can lead to improved default parameters that reduce average correction rates and processing time for subsequent document generations.
   By coordinating structured bullet-point processing, controlled prompt sentence construction, emotion-aware adjustment, and centralized verification, the server implements a technical pipeline that is specifically adapted to the characteristics of transformer-based generative AI models and networked communication environments. This pipeline yields measurable technical effects, such as reduced end-to-end document generation time, reduced error rates in generated text, decreased network bandwidth usage between server and external model, and improved consistency of style across large sets of documents. These improvements go beyond mere automation of human drafting work and instead modify and enhance the way in which the computer system as a whole processes and manages language data.

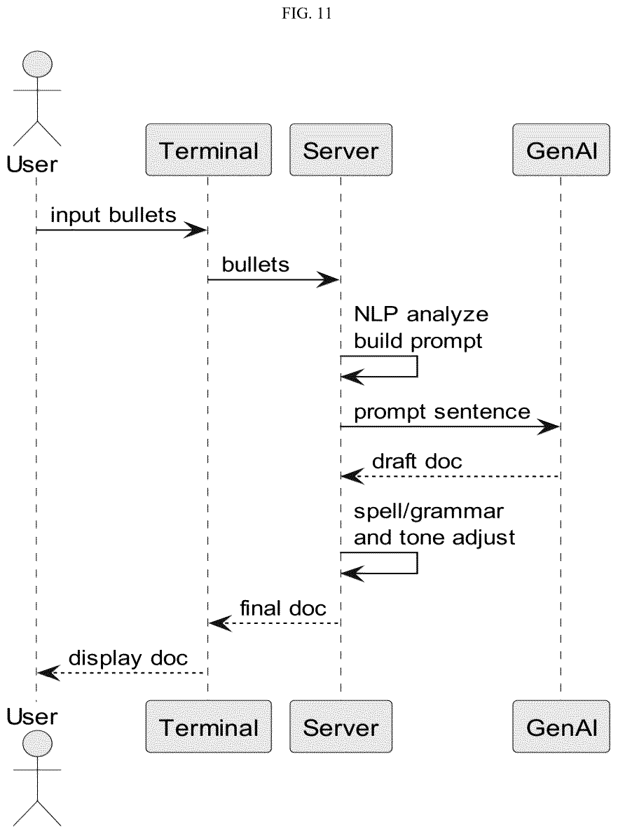

The following describes the processing flow using FIG. 11.

### Step 1:

The user operates the terminal to open a document-generation screen provided by an application. The terminal displays one or more text input fields for bullet-point entry.
Input: User keystrokes or touch inputs representing individual bullet items.
Processing: The terminal converts the physical input events into character strings using the terminal's operating system, and stores each bullet as an element in an ordered list data structure (for example, an array of strings) in memory.
Output: A structured list of bullet-point strings held in the terminal's memory.

### Step 2:

The user confirms the entered bullet points on the terminal and triggers a document generation action, for example by pressing a “Generate” button.
Input: The ordered list of bullet-point strings and the user's command to generate a document.
Processing: The terminal packages the bullet-point list into a request payload, encodes the strings (for example, in UTF-8), and attaches metadata such as user identifier and session identifier. The terminal then creates an HTTP request object containing the payload.
Output: A formatted HTTP request containing the bullet-point data and associated metadata, ready to be transmitted.

### Step 3:

The terminal transmits the HTTP request to the server via a communication network.
Input: The HTTP request with encoded bullet-point data.
Processing: The terminal uses its network stack (for example, TCP/IP) and an HTTP client module to send the request to a predefined server endpoint. The terminal ensures reliable transfer by fragmenting and reassembling packets as required by the network protocol.
Output: A network data stream delivered to the server's network interface.

### Step 4:

The server receives the HTTP request and extracts the bullet-point data.
Input: The network data stream representing the HTTP request.
Processing: The server's web server component parses the HTTP headers and body, decodes the payload (for example, JSON parsing and UTF-8 decoding), and converts the bullet-point portion into an internal list of string objects. The server validates that the list is non-empty and free of invalid characters.
Output: A validated list of bullet-point strings stored in server memory.

### Step 5:

The server performs natural language preprocessing on each bullet-point string.
Input: The validated list of bullet-point strings.
Processing: The server tokenizes each string into word or subword tokens using a tokenizer, assigns part-of-speech tags, and may perform dependency parsing. The server then generates vector embeddings for each bullet using an embedding model, and stores these vectors in an array or matrix.
Output: A set of annotated bullet representations, including tokens, linguistic tags, and embedding vectors.

### Step 6:

The server determines the document type and logical structure based on the annotated bullet representations.
Input: The annotated bullet representations with embeddings.
Processing: The server aggregates the embeddings (for example, by averaging or weighted summation) and feeds them into a classifier or rule-based module to determine a document type (such as email, report, or notice). The server uses mapping tables to associate semantic roles (such as “product,” “discount,” “period”) with positions in a document structure (such as subject, body paragraphs, conclusion).
Output: A document structure specification describing the document type, sections, and role assignments for content.

### Step 7:

The server constructs a prompt sentence for a generative AI model based on the document structure and bullet points.
Input: The document structure specification and the original bullet-point strings.
Processing: The server selects a template instruction text appropriate to the document type and desired style, and then concatenates this template text with each bullet point, formatting them as a human-readable list. The server may insert instructions regarding tone and audience.
Output: A prompt sentence text block containing instructions and bullet-point content, suitable for input to a generative AI model.

### Step 8:

The server prepares generation request data for the generative AI model.
Input: The constructed prompt sentence and system configuration parameters.
Processing: The server combines the prompt sentence with model parameters (such as model identifier, temperature, maximum tokens, and sampling settings) into a structured request object. The server serializes this object (for example, to JSON format) for API transmission.
Output: A generation request payload including the prompt sentence and control parameters.

### Step 9:

The server transmits the generation request payload to an external generative information processing apparatus and waits for a response.
Input: The generation request payload with prompt sentence and parameters.
Processing: The server uses an HTTP client library to send an HTTPS request to the external apparatus's API endpoint. The server manages authentication headers and implements timeout and retry policies to ensure robust communication.
Output: A request received by the external apparatus, and a pending state on the server awaiting generated document data.
Step 10:
The server receives business document data generated by the generative AI model.
Input: The HTTPS response from the external apparatus containing generated text.
Processing: The server parses the response body, extracts the generated document text field, and decodes it into a string. The server stores this string in a text buffer for subsequent processing.
Output: Raw generated business document text held in server memory.

### Step 11:

The server performs spelling and grammar analysis on the generated business document text.
Input: The raw generated business document text.
Processing: The server runs a spelling checker that compares each token against a lexicon and computes edit distances to suggest likely correct forms. The server also runs a grammar checker that uses grammar rules and statistical language models to detect agreement errors, misplaced punctuation, and other grammatical issues.
Output: A set of detected issues and corresponding correction proposals linked to positions in the document text.

### Step 12:

The server applies automatic corrections to the document text based on the correction proposals.
Input: The raw document text and the set of correction proposals.
Processing: The server filters the correction proposals using confidence thresholds and rule priorities, selects those that meet criteria for automatic application, and modifies the text buffer at specified positions to replace erroneous strings with corrected versions.
Output: A revised business document text with applied spelling and grammar corrections.

### Step 13:

The terminal transmits emotion estimation data to the server during or after user input.
Input: User interaction events on the terminal, such as keystroke timings, correction actions, and expression selections.
Processing: The terminal records timestamps of input events, counts deletions and insertions, and logs which suggested phrases are accepted or rejected. The terminal packages these measurements as behavior metrics and sends them to the server as a telemetry payload.
Output: A behavior data payload containing operation history and expression selection information delivered to the server.

### Step 14:

The server estimates the user's emotional state from the behavior data.
Input: The behavior data payload including operation history and expression selection information.
Processing: The server computes features such as average input latency, variance of latency, correction frequency per unit of text, and proportion of formal versus informal phrase selections. The server applies these features to a trained classifier or rule set to infer an emotional state label and associated confidence scores.
Output: An estimated emotional state record associated with the current document generation session.

### Step 15:

The server derives adjustment conditions based on the emotional state and preset user conditions.
Input: The estimated emotional state record and stored user preference data (including evaluation standards, expression standards, and prohibitions).
Processing: The server consults configuration records to map the emotional state and user preferences to explicit parameters, such as target tone (formal or casual), target length (concise or detailed), and allowed or prohibited expressions. These parameters are combined into an adjustment conditions object.
Output: Adjustment conditions specifying how tone, style, and detail level should be applied to prompts or document text.

### Step 16:

The server adjusts the prompt sentence and/or the generated business document text according to the adjustment conditions.
Input: The adjustment conditions, the prompt sentence, and the revised business document text.
Processing: If the system is to regenerate text, the server modifies the prompt sentence by inserting or altering instructions that reflect the desired tone and style. If the existing document is to be post-processed, the server runs a style-adjustment module that replaces phrases, alters sentence length, and modifies politeness expressions in accordance with the adjustment conditions.
Output: An emotion- and preference-adjusted prompt sentence and/or an adjusted business document text.

### Step 17:

The server prepares final output data to be transmitted to the terminal.
Input: The corrected and adjusted business document text, optionally with metadata such as applied corrections and adjustment summaries.
Processing: The server constructs a response object containing the final document text and any auxiliary information, serializes this object (for example, to JSON or another structured format), and sets appropriate response headers for transmission to the terminal.
Output: A response payload containing the final business document data in a displayable format.

### Step 18:

The terminal receives the response payload and renders the final business document for the user.
Input: The response payload from the server containing the final business document text.
Processing: The terminal parses the payload, extracts the text, and inserts it into a display component such as a text area or rich text editor. The terminal may visually distinguish corrected or stylistically adjusted segments based on optional metadata.
Output: A rendered business document displayed on the terminal's screen, ready for the user to review, further edit, or use in subsequent communication.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

In contemporary digital communication environments, computing systems are increasingly used to generate, edit, and distribute business communications, such as marketing messages and notification messages, to large recipient groups. Conventional systems that rely on template engines or static rule-based text generation frequently produce messages that are either generic, inconsistent with underlying campaign parameters, or misaligned with desired tone and style. With the emergence of generative AI models, it has become possible to automatically generate more natural and contextually rich communication documents. However, integration of generative AI models into communication workflows introduces several technical problems in computer processing.

First, conventional integrations typically pass user-provided bullet-point information directly to a generative AI model with a naive prompt sentence. Such approaches do not robustly control factual consistency between the generated text and the underlying structured parameters, such as numerical discount values or validity periods. As a result, a computing device may output a communication document containing incorrect numbers or dates, and there is no systematic computational mechanism for automatic detection and correction of such inconsistencies.
Second, conventional systems lack a processor-level mechanism for dynamically adjusting the content of prompt sentences in response to machine-readable quality criteria and expression criteria. For example, allowable character count, prohibited phrases, mandatory phrases, and brand expression policies are often managed as separate configuration items or manual guidelines, not as constraints that directly shape instructions passed to the generative AI model. This leads to repeated manual editing on user terminals, increased network traffic due to multiple trial-and-error generations, and inefficient use of computing and communication resources.
Third, traditional architectures do not provide a structured way to incorporate user emotional state into the generation and correction pipeline in a machine-usable format. Even when user sentiment is informally considered, it is typically handled outside the computational pipeline and does not influence the generative AI model through explicitly parameterized prompt sentences. As a consequence, the tone, style, and emotional nuance of generated communication documents are often misaligned with user intent or with the psychological profile of the target recipient group, requiring further manual adjustments and reducing the effective throughput of the communication system.
Fourth, known systems insufficiently log and correlate bullet-point inputs, prompt sentences, generative AI outputs, and distribution results in a form that can be computationally reused. Without structured, machine-readable linkage among these artifacts in persistent storage, later processing stages such as re-generation, quality analysis, or automated correction cannot efficiently exploit past data. This limits the ability of the system to self-improve, increases redundant computation, and complicates traceability for regulatory and compliance purposes. Accordingly, there is a need for a computer-implemented system that (i) systematically converts structured bullet-point information into prompt sentences with explicit generation constraints, (ii) automatically verifies and corrects generated communication documents, including their factual consistency with structured parameters, (iii) dynamically adjusts prompt sentences based on user-defined criteria and user emotional state, and (iv) persistently correlates inputs, prompts, outputs, and delivery results to improve subsequent processing. By addressing these issues at the processor and memory architecture level, the invention seeks to improve the functioning of the computer system itself, reduce manual editing operations on the user terminal, decrease unnecessary invocations of the generative AI model, and enhance the reliability and controllability of AI-assisted communication generation.

The specific processing by the specific processing unit 290 of the data processing device 12 in Application Example 1 is realized by the following means.

The present invention provides a server comprising a processor and a memory storing instructions that, when executed by the processor, cause the processor to receive, from a user terminal, input information in a structured bullet-point format; analyze the bullet-point format information by using generic natural language processing; construct, based on the analysis, instruction information including a prompt sentence that defines generation conditions of a communication document to be delivered to a recipient group, the prompt sentence being configured to be supplied to a generative AI model; obtain, from the generative AI model, a communication document candidate generated in response to the prompt sentence; verify the communication document candidate by using a character string analysis algorithm that detects notation errors and linguistic structure errors; mechanically correct content of the communication document candidate based on a verification result; automatically determine consistency between the communication document candidate and numerical information and period information included in the bullet-point format information; when an inconsistency is detected, automatically regenerate at least one of the communication document candidate and the prompt sentence by iteratively invoking the generative AI model with an updated prompt sentence; refer to quality criteria and expression criteria set by a user, and dynamically adjust content of the prompt sentence so that a communication document generated by the generative AI model conforms to the quality criteria and the expression criteria in terms of expression style, tone, and content modification; analyze an emotional state of the user based on biological information or operation history; generate an additional prompt sentence for adjusting tone, writing style, and emphasis portions of the communication document according to the emotional state and attribute information of the recipient group; supply the additional prompt sentence to the generative AI model to obtain a corrected communication document whose tone and style are controlled by parameters embedded in the prompt sentences; convert the corrected communication document into a message format suitable for a predetermined transmission medium; associate destination identification information with the corrected communication document; execute distribution processing that automatically transmits the corrected communication document to the recipient group via an electronic communication network; and store, in a recording medium, the bullet-point format information, each prompt sentence, each communication document candidate obtained from the generative AI model, and a result of the distribution processing in association with one another so as to make the stored information available as reference information in subsequent prompt sentence generation processing and communication document correction processing. This enables the computer system to more reliably and efficiently generate, correct, and distribute communication documents that are factually consistent with structured campaign parameters, compliant with user-defined policies, and adaptively tuned in tone and style based on user emotional state, thereby reducing manual post-editing, lowering redundant AI inference calls, improving utilization of computing and network resources, and enhancing overall performance and controllability of AI-assisted communication workflows.

The term “processor” refers to a hardware or virtual computation unit, such as a central processing unit or a processing core in a virtual machine, that executes machine-readable instructions to perform data processing operations described in the present disclosure.

The term “memory” refers to a non-transitory computer-readable storage medium, such as semiconductor memory, magnetic storage, or optical storage, that stores instructions and data to be accessed and processed by a processor.
The term “user terminal” refers to an information processing device operated by a user, such as a personal computer, a tablet device, or a mobile communication device, that transmits input information to a server and receives output information from the server via a communication network.
The term “structured bullet-point format” refers to a data representation in which multiple items of information are arranged as separate elements in a list or array, each element representing a concise item such as a feature, a condition, or a parameter used for communication document generation.
The term “input information” refers to data provided from a user terminal to a server, including at least bullet-point format information representing key items or parameters to be reflected in a generated communication document.
The term “generic natural language processing” refers to a set of software-implemented computational techniques, independent of a specific application domain, for analyzing natural language text, including but not limited to tokenization, part-of-speech tagging, syntactic parsing, and semantic analysis.
The term “prompt sentence” refers to a natural language instruction, or a set of natural language instructions, constructed by a processor and supplied to a generative AI model to control conditions, constraints, and style of text generation.
The term “instruction information” refers to data including at least one prompt sentence and one or more parameters, configured to specify how a generative AI model is to generate or modify a communication document.
The term “generative AI model” refers to a machine learning model, such as a neural network-based language model, configured to generate natural language text in response to input data including prompt sentences.
The term “communication document” refers to a natural language text generated or modified by a generative AI model and processed by a server for delivery to one or more recipients, including but not limited to marketing messages, notification messages, or business emails.
The term “communication document candidate” refers to a version of a communication document output by a generative AI model prior to or during verification and correction processing performed by a server.
The term “recipient group” refers to a plurality of recipients, identified by destination identification information, that constitute a target audience to which a communication document is to be delivered.
The term “character string analysis algorithm” refers to a software-implemented procedure that analyzes text as sequences of characters and words to detect notation errors, spelling errors, or linguistic structure errors.
The term “notation errors” refers to defects in a character string, including at least typographical mistakes, spelling mistakes, or incorrect symbols, that deviate from expected language norms.
The term “linguistic structure errors” refers to grammatical or syntactic mistakes in a text, including but not limited to incorrect word order, tense mismatch, and subject-verb disagreement.
The term “mechanically correct” refers to automatically modifying text content by a processor according to predefined rules, patterns, or program logic, without manual intervention from a human user.
The term “numerical information” refers to data items representing quantities or values, such as discount rates, prices, or counts, that are to be expressed consistently in a communication document.
The term “period information” refers to data items representing temporal conditions, such as start dates, end dates, validity periods, or deadlines, that are to be expressed consistently in a communication document.
The term “consistency” refers to a state in which factual elements, including numerical information and period information, appearing in a communication document match corresponding elements contained in the structured input information.
The term “quality criteria” refers to one or more machine-readable conditions set by a user or system administrator, including constraints on clarity, correctness, completeness, or style, that a generated communication document should satisfy.
The term “expression criteria” refers to one or more machine-readable rules, including allowable expressions, prohibited expressions, mandatory expressions, and brand-related wording guidelines, that govern how content in a communication document is to be phrased.
The term “expression style” refers to textual characteristics of a communication document, including sentence length, formality level, politeness level, and structural arrangement of information.
The term “tone” refers to an overall attitudinal or emotional quality expressed by a communication document, such as friendly, formal, urgent, or casual, as perceived by a recipient.
The term “content modification” refers to alteration of text in a communication document, by deletion, insertion, or rewriting, performed in order to satisfy quality criteria, expression criteria, or consistency constraints.
The term “user emotional state” refers to an internal affective condition of a user, such as positive, negative, or neutral sentiment, inferred from measurable indicators including biological information or operation history.
The term “biological information” refers to measurable physiological or biometric signals associated with a user, such as heart rate, skin conductance, or facial expression features, that can be used to infer an emotional state.
The term “operation history” refers to records of user interactions with a user terminal or application, including input patterns, editing behavior, selection behavior, or response times, from which an emotional state can be inferred.
The term “additional prompt sentence” refers to an extra or supplemental prompt sentence generated by a processor, configured to adjust tone, style, or emphasis in a communication document when supplied to a generative AI model.
The term “attribute information of the recipient group” refers to characteristics of recipients, such as demographic attributes, past behavior, or preference categories, used to influence how a communication document is generated or modified.
The term “corrected communication document” refers to a communication document that has been modified from an original communication document candidate to satisfy at least one of consistency constraints, quality criteria, expression criteria, tone requirements, or style requirements.
The term “predetermined transmission medium” refers to a communication channel type, such as electronic mail, push notification, or messaging protocol, for which a communication document is formatted and through which the communication document is transmitted.
The term “message format” refers to a structured representation of content suitable for transmission over a predetermined transmission medium, including layout, headers, metadata, and encoding.
The term “destination identification information” refers to data that uniquely identifies a recipient or recipient endpoint, such as an electronic mail address, a device token, or an account identifier, used for addressing a communication document.
The term “distribution processing” refers to a sequence of computer-executed operations that package, address, and transmit a communication document to members of a recipient group via an electronic communication network, and optionally record transmission results.
The term “electronic communication network” refers to a data transmission infrastructure, such as the Internet or a mobile communication network, that enables electronic exchange of information between a server and user terminals or recipient devices.
The term “recording medium” refers to a non-transitory storage resource, such as a database, file system, or other persistent storage, configured to store and maintain data for later access by a processor.
The term “stored information” refers to data that has been written to a recording medium, including but not limited to bullet-point format information, prompt sentences, communication document candidates, corrected communication documents, and distribution results.
The term “subsequent prompt sentence generation processing” refers to processing performed after initial operations, in which previously stored information is referenced by a processor to construct new or revised prompt sentences.
The term “communication document correction processing” refers to processing in which an existing communication document candidate is evaluated and modified based on stored information, quality criteria, expression criteria, or updated constraints, to generate a corrected communication document.
The term “parameters indicating adjustment content” refers to machine-readable values or flags that specify how tone, style, or emphasis of a communication document should be changed, which are generated from evaluation results of a user emotional state.
The term “emotional nuance” refers to subtle affective features in language, such as positivity, urgency, enthusiasm, or empathy, that are conveyed by word choice, phrasing, and style in a communication document.

In one embodiment, a server cooperates with one or more user terminals and a generative AI model execution environment to implement the claimed system. The server includes at least one processor and at least one memory device. The processor executes instructions of a server-side software stack, for example an application framework such as a web framework or an application server, running on a general-purpose computing machine such as a rack-mounted server or a virtual machine instance hosted in a cloud computing platform. The memory stores executable instructions and data structures including bullet-point information, prompt sentences, communication document candidates, corrected communication documents, user criteria, user emotional state parameters, and distribution logs.

The terminal operates as a client device and may be realized as a personal computer, a tablet device, or a mobile communication device such as a smartphone. The terminal executes client software such as a web browser or a native application, and presents graphical user interfaces for receiving bullet-point information from a user and for displaying generated communication documents. The terminal communicates with the server via an electronic communication network such as the Internet, using secure communication protocols such as HTTPS.
The server uses a generative AI model deployed on specialized hardware. In one example, the generative AI model is a transformer-based neural network language model executing on a cluster of graphics processing units, such as programmable graphics accelerators that support large-scale matrix multiplications and non-linear activation operations. The generative AI model includes an embedding layer, multiple multi-head self-attention layers, feed-forward layers, and a final projection layer that outputs probability distributions over a vocabulary of tokens. The generative AI model has been pre-trained on a corpus of natural language text in a self-supervised learning regime and optionally fine-tuned on domain-specific communication data via gradient-based optimization methods such as stochastic gradient descent or adaptive moment estimation. During training, the model minimizes a loss function such as cross-entropy between predicted token distributions and ground-truth token distributions, and updates weight parameters by backpropagating error gradients through the network layers.
The server stores model interaction parameters such as temperature, top-k or nucleus sampling thresholds, maximum token length, and stop conditions. The server configures these parameters dynamically according to the type of communication document to be generated, user-defined criteria, and expected communication channels, thereby optimizing generation speed and controlling text variability.
The server receives bullet-point information from the terminal as structured data. Internally, the server represents the bullet-point information as a list or array of item records, each record containing at least a text field and optionally metadata fields such as item priority, item category, numerical value, and time interval. For example, the server may store the following bullet-point information:
“new product launch”
“20% off for first-time buyers”
“offer valid until the end of this month”
   The server uses generic natural language processing modules to analyze each bullet-point item. Such modules may include a tokenizer that segments text into tokens, a part-of-speech tagger that assigns grammatical categories to tokens, and a named entity recognizer that identifies entities such as numerical values and date expressions. The server, for example, extracts a numerical discount value “20%” as a numerical feature and a time span “until the end of this month” as a temporal feature. The server stores these features in structured fields, such as a numeric discount field and a validity period field, to be used later for consistency verification.
   The server constructs a prompt sentence based on the analyzed bullet-point information. The server concatenates fixed instruction templates with the bullet-point items and with explicit constraints derived from user-defined quality criteria and expression criteria. For example, the server may generate the following prompt sentence in plain text:
   “Generate a customer-facing marketing email using a friendly and professional tone. Use less than 150 words. Base the content strictly on the following bullet points and do not change the discount rate or deadline:
new product launch
20% off for first-time buyers
offer valid until the end of this month.”
   The server may generate different prompt sentences for different channels or purposes. For an alternative embodiment, the server may construct a more detailed prompt sentence that explicitly encodes brand requirements:
   “Based on the bullet points below, generate a concise promotional email in English. Use a polite but enthusiastic tone, avoid slang, include the brand name ‘Company X’ once in the first sentence, and do not modify any numbers or dates mentioned in the bullet points:
new product launch
20% off for first-time buyers
offer valid until the end of this month.”
   By explicitly embedding constraints and instructions into the prompt sentence, the server shapes the behavior of the generative AI model in a way that is not achievable by mere manual prompts, thereby improving control over generated content. This structured construction of prompt sentences is performed programmatically based on machine-readable criteria and extracted features, and thus constitutes a specific improvement to the way computing systems prepare inputs for neural text generation.
   The server supplies the constructed prompt sentence and associated parameters to the generative AI model execution environment through an application programming interface. The server transmits the prompt sentence as input text, together with model configuration parameters, to an inference endpoint that performs forward-pass computation through the transformer layers. The generative AI model encodes the prompt sentence into high-dimensional embeddings, processes the embeddings through attention layers that compute attention scores over token positions, and generates output token probabilities step by step. The server receives the generated tokens from the inference endpoint and reconstructs them into a communication document candidate in natural language.
   The server performs a verification operation on the communication document candidate. The server applies a character string analysis algorithm that includes sub-modules for spelling error detection, grammar error detection, and style conformance checking. For example, the server may incorporate a statistical or rule-based grammar checker that identifies subject-verb agreement errors, verb tense inconsistencies, or sentence fragments. The server may also use a dictionary-based or model-based spelling checker to identify typographical mistakes. The server modifies the communication document candidate according to a set of deterministic correction rules. These correction rules are stored as machine-readable patterns, such as regular expressions and transformation templates, and are executed automatically by the processor without human intervention.
   The server also verifies factual consistency by comparing numerical and temporal features present in the communication document candidate with the structured features extracted from the original bullet-point information. The server uses pattern matching and semantic parsing to extract numerical values and temporal expressions from the generated text. For example, the server detects any occurrence of a percentage pattern and parses it into a numeric value; similarly, the server detects phrases like “end of this month” and maps them to an internal temporal representation. If the server finds that the communication document candidate contains “10%” while the bullet-point features indicate “20%,” the server flags this as an inconsistency and either automatically corrects the numeric value in the text or regenerates the document by composing a corrective prompt sentence such as:

“Correct the following email so that it clearly states a 20% discount valid until the end of this month, without changing any other details:
[previous draft text]”
   This combination of structured feature extraction and automatic consistency verification reduces the risk of factual errors and prevents inconsistent messages from being delivered.
   From a technical standpoint, this reduces error propagation and retries in downstream distribution processes, and improves data integrity within the communication pipeline.
   The server uses quality criteria and expression criteria defined by the user to further control generation. The server stores these criteria as structured configuration data, such as maximum character count, banned phrases, required phrases, and style flags indicating formality level or level of enthusiasm. The server converts such criteria into parameter vectors and symbolic constraints that are used during prompt sentence construction and post-generation filtering. For example, if a banned phrase is detected in the communication document candidate, the server systematically rewrites the corresponding phrase using a synonym list or calls the generative AI model with a refinement prompt sentence that forbids the banned phrase. This process is implemented as a non-conventional pipeline that tightly integrates configuration-based constraints with both neural generation and deterministic text rewriting, thereby improving the controllability and reliability of the entire system.

The server analyzes user emotional state by processing one or more types of signals such as operation history, editing behavior, or optional biometric indicators. The server may, for instance, compute sentiment scores from text typed by the user, or evaluate interaction metrics such as time spent editing previous drafts, frequency of revision, or selection of stronger or milder wording. The server represents the user emotional state as a set of numeric parameters, such as an arousal score and a valence score, computed via a machine learning model or a rule-based classifier. The server encodes these parameters into additional prompt sentences that explicitly request a desired tone or emotional nuance. An example of such an additional prompt sentence is:

“Adjust the following email so that it sounds more calm and reassuring, while preserving all factual details and keeping the length under 150 words:
[previous draft text]”
   or
   “Adjust the following email so that it sounds more energetic and enthusiastic, while strictly keeping the discount rate at 20% and the deadline as the end of this month:
[previous draft text]”
   The server provides these additional prompt sentences to the generative AI model. Because the emotional state parameters are computed by the server and consistently embedded into prompt sentences, the tone and style of generated communication documents become reliably adjustable in a machine-controllable manner. This differs from human-only editing, because the system uses an explicit computational mapping from measurable signals to parameterized tone control, improving reproducibility and reducing reliance on subjective human interpretation.
   The server converts the corrected communication document into a message format compatible with the chosen transmission medium. For electronic mail, the server constructs headers, subject lines, and body sections in a format such as MIME, and may embed the text within an HTML template that includes standardized headers, footers, and compliance-related links. For push notifications, the server encodes the text as a payload field in a structured message format expected by a push notification service. The server associates destination identification information, such as electronic mail addresses or device identifiers, with the corrected communication document, and stores this association in a data structure such as a sending queue.
   The server executes distribution processing by iterating through entries in the sending queue and transmitting the messages through appropriate external communication services. For instance, the server may send email messages via an email transfer interface or may invoke a remote push notification gateway via programmatic interfaces. The server records transmission results, including success or failure codes, timestamps, and any error messages returned by external services. The server maintains these records in persistent storage, linked to the originating bullet-point information and prompt sentences.
   The server stores, in a recording medium such as a relational database or a log repository, the bullet-point information, all versions of prompt sentences, communication document candidates, corrected communication documents, user criteria snapshots, emotional state parameters, and distribution results. The server uses structured identifiers to link these data objects together. In subsequent operations, the server accesses the stored information to improve new prompt sentence construction and communication document correction. For example, the server may analyze historical pairs of bullet-point sets and successful communication documents to automatically infer better prompt patterns or default tone parameters, thereby improving future generation accuracy.
   From a technical perspective, this architecture provides several improvements over conventional systems. By representing bullet-point information and extracted features in structured form and performing automated consistency verification, the server reduces the rate of factual errors and therefore decreases the need for re-sending corrected communications, which in turn reduces network load and processing time. By using configuration-driven prompt sentence construction and deterministic post-processing algorithms, the server reduces the number of generative AI model invocations required to obtain an acceptable communication document, thereby decreasing inference costs and improving end-to-end latency.
   Additionally, by logging and correlating input data, prompt sentences, model outputs, and delivery results in a unified data structure, the server enables efficient retrieval and re-use of past processing outcomes. This structured accumulation of interaction history is used by the server to adjust model parameters, prompt templates, or filtering rules over time, which improves the precision and robustness of the system without requiring manual reconfiguration.
   Alternative embodiments may modify the underlying components while preserving the same core functional structure. For example, the server may employ different natural language processing toolkits or grammar checkers, may utilize different types of generative AI models such as encoder-decoder architectures instead of pure decoder-only transformers, or may derive user emotional state exclusively from operation history without biometric data. In another embodiment, the server may be implemented as a distributed system in which separate microservices handle prompt construction, AI inference orchestration, consistency checking, tone adjustment, and message distribution, respectively.
   The terminal may likewise vary in implementation details. One terminal embodiment may present a text-only user interface, while another may visually highlight mismatches between bullet-point features and drafted text, thereby guiding the user in approving or revising generated communication documents. Still another terminal embodiment may allow the user to adjust sliders corresponding to tone or formality, which the server translates into numeric parameters embedded in prompt sentences.
   By focusing on structured data representations, programmatic construction of prompt sentences, automated consistency and quality verification, and machine-controllable tone adjustment driven by computed emotional state parameters, the system improves the manner in which computers generate and manage communication documents. The improvements arise not merely from automating an existing manual drafting process, but from introducing specific computational procedures and data structures that enhance accuracy, efficiency, and controllability of AI-assisted text generation in a networked communication environment.

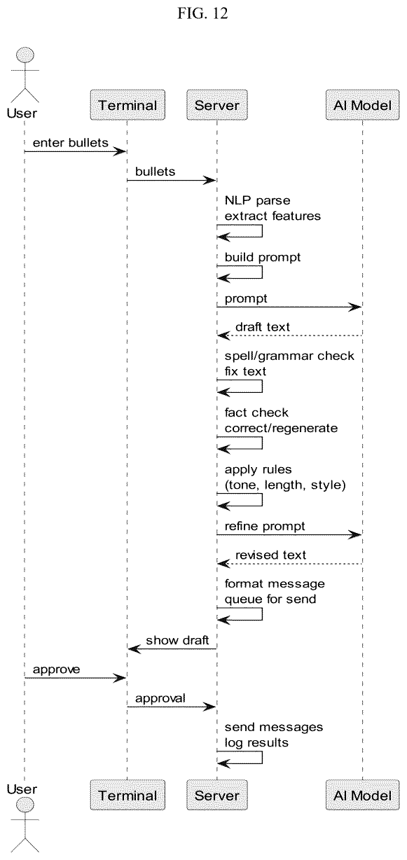

The following describes the processing flow using FIG. 12.

### Step 1:

User operates the terminal to input bullet-point information.
User views an input screen on the terminal and types multiple bullet items representing campaign conditions and key points, such as “new product launch”, “20% off for first-time buyers”, and “offer valid until the end of this month”.
Input: Raw text typed into form fields or list items on the terminal UI.
Output: A structured list of bullet items held in the terminal's local data model.
Based on the input, the terminal groups each bullet into an element of an internal list or array, normalizes whitespace, and assigns identifiers to each item so that the server can later reference them individually.

### Step 2:

Terminal sends the structured bullet-point information to the server.
Terminal serializes the list of bullets into a structured representation and attaches optional metadata such as language code, campaign type, and channel type.
Input: Internal list/array of bullet items and metadata on the terminal.
Output: A network request payload transmitted to the server.
Terminal encapsulates the bullet list into a request body, sets appropriate headers, and sends the payload over an electronic communication network using a secure protocol so that the server can receive all bullet items as structured data.

### Step 3:

Server receives and parses the bullet-point information.
Server accepts the incoming network request, reads the payload, and decodes the structured representation into in-memory objects.
Input: Network request payload containing bullet items and metadata.
Output: Server-side data structures representing each bullet item and associated metadata.
Server validates the data by checking that bullet items are non-empty strings, that metadata values fall within expected ranges, and that the request conforms to an internal schema, discarding or flagging malformed entries.

### Step 4:

Server performs natural language analysis on each bullet item.
Server applies natural language processing modules such as tokenization, part-of-speech tagging, and entity recognition to extract numerical and temporal features.
Input: Server-side bullet-item strings.
Output: A feature-enhanced representation for each bullet, including tokens, part-of-speech tags, and structured fields for numbers and dates.
Server identifies patterns such as percentages, currency values, and time expressions, converts them into normalized internal formats (for example, a floating-point discount value and a standardized validity period), and attaches these to the bullet records.

### Step 5:

Server constructs a primary prompt sentence for the generative AI model.
Server combines fixed instruction templates with the analyzed bullet items and with user-defined constraints (for example, maximum length or required tone).
Input: Feature-enhanced bullet records and stored configuration criteria.
Output: A primary prompt sentence as a continuous natural language instruction string.
Server concatenates instruction phrases and bullet text to form, for example:
“Generate a customer-facing marketing email using a friendly and professional tone. Use less than 150 words. Base the content strictly on the following bullet points and do not change the discount rate or deadline:
   new product launch
   20% off for first-time buyers
   offer valid until the end of this month.”
      Server stores this prompt sentence in memory, linked to the bullet set.

### Step 6:

Server prepares and sends a generation request to the generative AI model.
Server embeds the prompt sentence and model parameters into an inference request to the external or internal AI service.
Input: Primary prompt sentence and model configuration (for example, model name, temperature, max tokens).
Output: A model-inference request transmitted to the generative AI model endpoint.
Server constructs a request object that contains the prompt string, numeric parameters controlling randomness and length, and any stop conditions, then transmits this object over a network connection to the inference environment.

### Step 7:

Generative AI model computes a communication document candidate.
Generative AI model encodes the prompt sentence into embeddings, passes them through multiple transformer layers, and generates output tokens by sequential sampling from token probability distributions.
Input: Prompt sentence and model parameters received from the server.
Output: A sequence of output tokens representing a draft communication document.
Generative AI model multiplies embedding vectors by learned weight matrices, applies attention mechanisms to compute context-sensitive representations, and at each generation step selects the next token based on computed probabilities, until a termination condition is met.

### Step 8:

Server receives and reconstructs the communication document candidate.
Server reads the response from the generative AI model, extracts the sequence of tokens, and converts them into a text string.
Input: Token sequence and metadata returned from the generative AI model.
Output: A raw communication document candidate in natural language text.
Server joins tokens with appropriate spacing, normalizes character encoding, removes any leading or trailing artifacts, and stores the resulting text in association with the original bullet set and prompt sentence.

### Step 9:

Server executes spelling and grammar verification on the candidate.
Server applies a character string analysis algorithm to detect notation errors and linguistic structure errors in the candidate document.
Input: Raw communication document candidate text.
Output: An annotated version of the candidate text and a list of detected error locations and suggested corrections.
Server scans the text with rule-based and statistical checkers, marks incorrect spellings, flags grammar violations such as subject-verb disagreement, and generates suggested replacements, then records these annotations for later correction.

### Step 10:

Server mechanically corrects the candidate based on annotations.
Server applies correction rules to automatically replace or adjust erroneous segments in the document.
Input: Annotated candidate text and a set of deterministic correction rules.
Output: A mechanically corrected communication document version.
Server iterates over each error, performs string substitutions or local rewrites according to matching patterns, and recalculates any affected punctuation or capitalization so that the corrected text is linguistically consistent.

### Step 11:

Server verifies factual consistency with structured bullet features.
Server extracts numerical and temporal expressions from the corrected document and compares them with the previously stored features from the bullet items.
Input: Corrected communication document text and feature-enhanced bullet records.
Output: A consistency report indicating matches, mismatches, and any missing required facts.
Server uses pattern matching and parsing to identify all percentages and date phrases, converts them into normalized forms, and performs equality or range comparisons against stored discount values and validity periods, marking any discrepancies.

### Step 12:

Server performs automatic factual correction or regeneration when inconsistencies exist.
Server decides whether to rewrite specific segments or request a new draft from the generative AI model.
Input: Consistency report, corrected document text, and bullet features.
Output: Either a further corrected document or an updated prompt sentence to regenerate text.
Server, for minor discrepancies, directly substitutes correct numbers or dates in-place using the bullet features; for broader inconsistencies, server composes a refinement prompt sentence, such as:
“Correct the following email so that it clearly states a 20% discount valid until the end of this month, without changing any other details:
[previous draft text]”
and initiates another model call as in Step 6.

### Step 13:

Server adjusts the prompt sentence according to quality and expression criteria.
Server reads user-defined constraints such as maximum length, banned phrases, mandatory tags, and desired formality, and encodes them into the next prompt.
Input: Stored configuration criteria and current state of the document or draft.
Output: A revised prompt sentence that more strictly encodes the criteria.
Server adds or modifies instructions within the prompt, for example appending directives like “avoid using slang” or “include a clear call-to-action in the last sentence,” and records the updated prompt as part of the campaign's history.

### Step 14:

Server evaluates user emotional state and derives tone-control parameters.
Server processes user interaction data, previous editing behavior, or optional biometric indicators to infer sentiment and preferred tone.
Input: User operation history data and any available emotional indicators.
Output: A set of numeric tone-control parameters (for example, formality level, enthusiasm level) and a tone label.
Server computes aggregated scores by applying a classifier or rule set that maps measurable signals to numeric values, then stores these values as part of a tone-control profile linked to the user and campaign.

Step 15:
Server generates an additional prompt sentence for tone and style adjustment.
Server converts the tone-control parameters into explicit textual instructions directing the model to adjust tone, style, and emphasis.
Input: Tone-control parameters, current communication document text, and recipient group attributes.
Output: An additional prompt sentence requesting a tone-adjusted revision.
Server composes text such as:
“Adjust the following email so that it sounds more calm and reassuring, while preserving all factual details and keeping the length under 150 words:
[previous draft text]”
and stores this sentence as a refinement instruction.

### Step 16:

Server obtains a tone-adjusted corrected communication document from the generative AI model.
Server sends the additional prompt sentence to the model and receives a revised document.
Input: Additional prompt sentence and previous draft text embedded within it.
Output: A tone-adjusted corrected communication document.
Server invokes the model inference endpoint as in Step 6, obtains a new sequence of tokens, reconstructs a text version, and verifies that factual constraints remain satisfied by re-running consistency checks similar to Step 11.

### Step 17:

Server formats the corrected communication document for a specific transmission medium.
Server wraps the final text into an appropriate message structure, such as an email message or a push notification payload.
Input: Tone-adjusted corrected communication document and channel specification.
Output: A formatted message object suitable for transmission.
Server constructs subject lines, headers, and body sections for electronic mail, or constructs compact message bodies and metadata fields for push notifications, adjusting line breaks, encoding, and any required markup.

### Step 18:

Server associates destination identification information with the formatted message.
Server retrieves or receives a list of recipient identifiers and binds each identifier to the formatted message or to a personalized variant.
Input: Formatted message object and recipient group data.
Output: A sending queue or list of message-recipient associations.
Server iterates over the recipient set, optionally merges personalized fields (such as recipient name) into copies of the message, and stores each message-recipient pair as an entry ready for distribution.

### Step 19:

Server executes distribution processing via communication services.
Server transmits each message-recipient entry through an external communication service appropriate to the medium.
Input: Sending queue with message-recipient entries.
Output: Transmission attempts and received status responses.
Server calls external interfaces, such as email gateways or push notification services, sends the formatted messages, and receives acknowledgement codes or error responses, logging these for each recipient.

### Step 20:

Server records all processing artifacts and results in persistent storage.
Server writes the bullet-point information, prompt sentences, model outputs, corrected documents, configuration criteria, tone-control parameters, and transmission logs into a recording medium with relational identifiers.
Input: All intermediate and final data objects produced during processing.
Output: Persistent records linked by identifiers for future retrieval and analysis.
Server organizes these records into tables or structured logs, indexes them by campaign and timestamp, and updates summary statistics that can be used to refine future prompt sentences and correction strategies.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional document generation systems that utilize generative AI models generally treat such models as a black-box component that receives a static prompt and returns a single-pass output. In these systems, a computing device typically forwards user input directly to the model and then presents the generated text to the user with minimal or no structured post-processing. As a result, several technical problems arise in terms of computer technology.

First, because the generated text is not subjected to a systematic, machine-executed pipeline of verification, correction, and style adjustment, the quality and consistency of the output are highly dependent on the user's manual review. The computing resources of the server and the terminal are used in a single forward generation operation, and the subsequent error detection and style harmonization are often performed by the human user, which introduces latency that is not visible to the system and leads to inefficient utilization of processing resources.
Second, conventional systems do not maintain machine-readable, structured traceability of intermediate representations across multiple stages of processing (for example, generation, confirmation, correction, and adjustment). Because information such as intermediate drafts, detected error information, and applied corrections is not consistently recorded and associated with the original prompt, the system cannot effectively analyze or optimize its own behavior. This limits the ability of the computing system to dynamically adapt prompts, model parameters, or post-processing steps based on historical performance, and reduces the overall robustness and reliability of the text generation pipeline.
Third, in many systems, the user's tone preferences and emotional state are either ignored or embedded only implicitly in free-form instructions. The computing device does not systematically acquire user-related emotional information or criterion information, nor does it algorithmically transform such information into structured editing instruction information. Consequently, the server cannot programmatically control the tone and style of generated communications in a reproducible way. This leads to inconsistencies across communications and forces the user to repeatedly adjust tone and style manually, which again results in inefficient use of computing resources and network bandwidth through repeated generation cycles.
Fourth, existing approaches often construct prompts for the generative AI model in a fixed or static fashion. The prompts used to instruct the model for confirmation and correction of content are not dynamically adjusted based on stored association information between prior prompt sentences, user criteria, and model outputs. Without such dynamic prompt adjustment logic implemented at the processor level, the system cannot leverage prior interactions to refine how it invokes the generative AI model, and thus cannot improve the computational efficiency, accuracy, and consistency of the generated documents over time.
Therefore, there is a need for a computer-implemented system that structures the interaction with a generative AI model into multiple programmable stages, that records and manages intermediate information and processing history in a traceable manner, that uses user-specific criterion information and emotional state as machine-interpretable signals for automatic tone and style control, and that dynamically adjusts prompts for the generative AI model based on stored association information. Such a system would improve the functioning of the underlying computer technology by enabling more efficient, reliable, and controllable generation, correction, and adjustment of communication documents within a server-terminal architecture.

The specific processing by the specific processing unit 290 of the data processing device 12 in Example 2 is realized by the following means.

The present invention provides a server comprising a processor configured to receive character information as input from a terminal apparatus, analyze list-format information included in the character information, and generate a prompt sentence that instructs a generative information processing model to generate a communication document based on the list-format information; call the generative information processing model as an external information processing apparatus based on the prompt sentence and criterion information set by a user, and cause the generative information processing model to generate the communication document from the prompt sentence; apply a character-string analysis algorithm and a language-structure analysis algorithm to the generated communication document to detect error information and grammatical error information, and automatically correct the communication document based on the error information and the grammatical error information; acquire emotion information relating to the user and the criterion information set by the user, generate editing instruction information for adjusting tone information and style information of the communication document based on the emotion information and the criterion information, and automatically adjust content of the communication document based on the editing instruction information; store intermediate information and processing history information corresponding to respective processing stages including a generation process, a confirmation process, a correction process, and an adjustment process of the communication document as recording information, manage a generation procedure of the communication document in a traceable manner based on the recording information, and store, in association with each other, the prompt sentence, the criterion information set by the user, and the communication document output from the generative information processing model, and dynamically adjust, based on stored association information, a prompt sentence for instructing the generative information processing model to confirm and correct content of the communication document. This enables the server-side computer system to execute a multi-stage, machine-controlled pipeline for generation, correction, and tone/style adjustment of communication documents, to leverage recorded intermediate and association information to dynamically refine prompts and processing behavior over time, and thereby to improve the technical performance, reliability, and efficiency of document generation operations carried out by the computing infrastructure.

The term “character information” refers to digital text data comprising one or more characters, symbols, or strings that are input to, processed by, or output from a computing device.

The term “list-format information” refers to structured text data that represents multiple items arranged in a list form, including bullet lists, numbered lists, or other ordered or unordered collections of textual elements.
The term “prompt sentence” refers to text data that is generated or provided for the purpose of instructing a generative information processing model to perform a specific processing operation, including generation, confirmation, correction, or adjustment of a communication document.
The term “generative information processing model” refers to a computational model, such as a machine learning model or neural network, that generates new text data in response to input text data, including a prompt sentence, by probabilistically predicting and outputting a sequence of tokens.
The term “communication document” refers to electronic text content that is intended for transmission or presentation to a recipient, including but not limited to messages, letters, emails, notices, or reports generated based on a prompt sentence.
The term “external information processing apparatus” refers to a computing resource that is separate from a main server processor and that executes information processing, such as generative modeling, in response to a request from the server processor, including a remote server, cloud service, or dedicated accelerator.
The term “criterion information” refers to parameter data or setting data specified by a user or system, which define conditions, preferences, or constraints for generation, correction, or adjustment of a communication document, including tone, style, length, and level of detail.
The term “error information” refers to data indicating detected errors in a communication document, including spelling errors, typographical errors, lexical errors, and syntactic inconsistencies.
The term “grammatical error information” refers to data indicating detected grammatical issues within a communication document, including incorrect tense, agreement, word order, or other violations of grammatical rules.
The term “character-string analysis algorithm” refers to a computational procedure that analyzes sequences of characters or tokens to detect patterns, errors, or features in text data, including spell-checking algorithms and lexical analyzers.
The term “language-structure analysis algorithm” refers to a computational procedure that analyzes structural aspects of text, such as syntax or part-of-speech relationships, to detect grammatical errors or to derive linguistic features.
The term “emotion information” refers to data representing an emotional state or affective condition of a user, obtained or inferred from user input, behavior, biological signals, or self-reports.
The term “tone information” refers to attribute data or feature data that characterize the manner or attitude expressed in a communication document, including levels of formality, politeness, friendliness, urgency, or assertiveness.
The term “style information” refers to attribute data or feature data related to the stylistic characteristics of a communication document, including sentence complexity, vocabulary choice, level of technical detail, and formatting preferences.
The term “editing instruction information” refers to structured data that specifies how a communication document should be modified, including instructions for changing tone, style, length, or content based on emotion information and criterion information.
The term “intermediate information” refers to data representing one or more intermediate states or versions of a communication document or associated metadata produced at different stages of a processing pipeline, such as initial drafts, partially corrected texts, or interim analysis results.
The term “processing history information” refers to data that records operations performed on a communication document over time, including timestamps, applied algorithms, model calls, corrections, and adjustments.
The term “recording information” refers to stored data that includes intermediate information and processing history information, which together allow tracking and reconstruction of the processing applied to a communication document.
The term “generation process” refers to a processing stage in which a communication document is first produced by a generative information processing model in response to a prompt sentence.
The term “confirmation process” refers to a processing stage in which a generated communication document is automatically inspected or reviewed by a computing device to detect errors or inconsistencies.
The term “correction process” refers to a processing stage in which detected errors in a communication document are automatically modified or replaced by a computing device based on error information and grammatical error information.
The term “adjustment process” refers to a processing stage in which tone information, style information, or other attributes of a communication document are modified according to editing instruction information, emotion information, or criterion information.
The term “generation procedure” refers to a sequence of processing steps, including generation, confirmation, correction, and adjustment, applied to produce a final communication document from initial input character information.
The term “association information” refers to stored data that links or correlates multiple items, such as a prompt sentence, criterion information, and an output communication document, in a manner that allows joint retrieval and analysis.
The term “operation information” refers to data representing user operations detected by a terminal apparatus or server, including keystrokes, pointer actions, navigation events, input timings, and selection actions.
The term “biological measurement information” refers to data obtained from sensors that measure biological or physiological parameters of a user, including heart rate, skin conductance, facial expressions, or voice characteristics.
The term “self-report information” refers to data that a user directly inputs to describe their own emotional state, preferences, or conditions, including questionnaire responses and free-text descriptions.
The term “terminal apparatus” refers to an end-user computing device that communicates with a server, including but not limited to a smartphone, tablet device, personal computer, or other network-connected device capable of inputting and displaying text.
The term “server” refers to a computing device or computing system that includes at least one processor and memory, and that is configured to perform centralized processing operations, including interaction with a generative information processing model, and communication with one or more terminal apparatuses.

The server, the terminal, and the user cooperate to implement embodiments of the invention as described below. In the following, “server” denotes a data processing apparatus including at least one processor and memory, “terminal” denotes a user-operated client device, and “user” denotes a human operator.

The server includes one or more general-purpose processors (for example, x86 or ARM processors), volatile memory (for example, DRAM), non-volatile storage (for example, SSD), and a network interface. The server executes an operating system such as a general-purpose server operating system and application software including a web application framework such as a server-side scripting framework, a database management system such as a relational or document database, and a client library for accessing a generative AI model via an application programming interface. The server further includes, or is connected to, an accelerator device such as a graphics processing unit on which a generative AI model is deployed using a machine learning framework such as a tensor-based deep learning library. The terminal includes at least one processor, memory, a display device, and an input device such as a keyboard or touch panel. The terminal executes a web browser or a native application that presents a graphical user interface to the user. The terminal communicates with the server over a network such as the Internet via a secure communication protocol. The user operates the terminal to access a document-generation application provided by the server. The terminal displays an input area for a prompt sentence and for list-format information. The user inputs list-format information in the form of multiple bullet points or ordered items, such as:
New product features: improved security, faster performance, cloud integration
Target customers: enterprise clients in the financial sector
Desired tone: formal, confident
   The user also inputs a prompt sentence such as:
“Please create an email to announce the release of a new cloud service to our enterprise customers. Emphasize scalability and cost savings.”
   or
“Draft a formal apology email to a client for a delivery delay of three days.”
   The terminal converts the prompt sentence and the list-format information into structured request data. The terminal associates the structured request data with user-specific criterion information, such as a selected tone (“formal”), length (“short”), and style preferences (“avoid technical jargon”), as stored locally or retrieved from the server. The terminal transmits the structured request data to the server as character information using a predetermined communication protocol.
   The server receives the character information from the terminal. The server stores the received character information, including the raw prompt sentence, the list-format information, and the user's criterion information, in a database using specific data structures. For example, the server associates a request identifier with a prompt table entry, a criteria table entry, and a document table entry. The server parses the character information using natural language processing libraries resident on the server. The server identifies list-format information by detecting delimiters such as bullet markers, numbers followed by punctuation, or HTML list tags, and transforms the list items into an internal representation, such as a vector of token sequences, that explicitly encodes item boundaries.
   The server generates a prompt sentence for a generative AI model by algorithmically combining the list-format information, the user's original prompt sentence, and the user's criterion information. The server constructs this prompt sentence according to deterministic rules, for example, by inserting each list item under a labeled section such as “Key points:” or “Constraints:”, and by attaching explicit instructions about tone and style. The server thereby produces a structured prompt sentence such as:
“You are a document generation engine for business communications.
User requirements:
   Key points: [list of items]
   Tone: formal
   Length: medium
Task:
Generate a complete email that satisfies the above requirements.”
   By doing so, the server controls the generative AI model with more granularity than a conventional free-form prompt, which improves the consistency and predictability of the generated communication document.
   The server invokes a generative AI model deployed as a neural network on a remote or local computing resource. In one embodiment, the generative AI model is implemented as a transformer-based neural network including multiple encoder-decoder layers, self-attention modules, and feed-forward layers. The server passes the prompt sentence to the generative AI model through a model-serving interface. The generative AI model internally tokenizes the input, maps tokens to embedding vectors, applies multi-head attention to compute contextualized representations, and sequentially predicts output tokens according to learned probability distributions. The model parameters, such as weights in attention matrices and feed-forward layers, have been trained in advance by minimizing a loss function such as cross-entropy over large text corpora using optimization algorithms such as stochastic gradient descent with adaptive moment estimation. During training, the model may use data augmentation techniques such as random masking or permutation of text fragments to improve robustness.
   The server receives the sequence of predicted tokens and reconstructs a generated communication document as plain text. The server records this generated communication document in the database as intermediate information associated with the original prompt sentence and criterion information. By recording this association, the server can later analyze model behavior and adjust future prompts.
   The server performs automatic verification and correction of the generated communication document. The server applies a character-string analysis algorithm that performs spelling checks and typographical error detection. This algorithm uses a dictionary and tokenization rules to identify unknown or unlikely words and replace them with candidate corrections based on edit distance metrics. The server also applies a language-structure analysis algorithm such as a dependency parser or a part-of-speech tagger that detects grammatical errors, including incorrect subject-verb agreement and incorrect tense usage. In one embodiment, the server combines these rule-based or statistical tools with an additional call to the generative AI model, providing an instruction-focused prompt sentence such as: “Correct spelling and grammar in the following email without changing its meaning.”
   By combining deterministic algorithms and model-based rewriting, the server generates a corrected version of the communication document. The server stores both the detected error information and grammatical error information, as well as the corrected document, in the database as processing history information.
   The server acquires emotion information and criterion information related to the user. The server may obtain emotion information from operation information, such as the speed and pattern of user typing detected by the terminal, from biological measurement information such as heart rate or facial expression data captured by sensors associated with the terminal, or from self-report information where the user directly indicates an emotional state such as “stressed” or “relaxed.” The server processes these signals using a classifier model implemented as a smaller neural network (for example, a feed-forward network or a recurrent network) that has been trained to output discrete emotional categories based on vectorized features of the operation sequence or biometric signals. The server thereby evaluates an emotional state of the user and quantizes it into emotion information that can be integrated with criterion information.
   The server generates editing instruction information that specifies how tone information and style information of the communication document should be adjusted based on the emotion information and the criterion information. For instance, if the emotion information indicates that the user is highly stressed and the criterion information indicates a requirement for politeness, the server may generate editing instruction information that enforces a calm and reassuring tone, short sentences, and explicit acknowledgments of the recipient's time. The server encodes these instructions in a structured internal representation, such as a key-value map indicating desired tone, sentence length, formality level, and permissible vocabulary ranges.
   The server then uses the editing instruction information as conditioning input for a further invocation of the generative AI model. The server constructs a prompt sentence that includes the corrected communication document and the desired transformations, for example: “Rewrite the following email so that it is formal and concise, avoids technical jargon, and maintains a polite and calm tone appropriate for a stressed sender.”
   The generative AI model processes this prompt sentence and the included document text to produce an adjusted communication document with revised tone and style. The server stores this adjusted communication document and associates it with the corresponding editing instruction information in the database.
   The server maintains recording information that includes intermediate information and processing history information for each document. The server logs data for each stage generation, confirmation, correction, and adjustment including timestamps, algorithm identifiers (for example, the specific grammar checker or model version), and diff data representing changes between document versions. By storing this recording information in a structured format, such as normalized database tables or indexed document storage, the server enables traceable reconstruction of the full generation procedure for any communication document.
   The server leverages the stored association information between prompt sentences, criterion information, and output documents to dynamically adjust future prompts. For example, the server analyzes historical association information to identify prompt phrasings that led to fewer corrections or smaller adjustments in a particular domain. The server automatically updates templates for prompt construction by modifying instruction phrases, ordering of list items, or additional constraints. This dynamic adaptation of prompts reduces the number of iterations required to reach an acceptable document, which decreases overall computation time and network traffic between the server and the generative AI model, resulting in reduced latency and improved throughput.
   The terminal receives the adjusted communication document from the server. The terminal parses the received data and renders the communication document on the display in a text area. The user reviews the communication document and may optionally perform minor manual edits. The terminal can also provide further options, such as saving the document locally, using it as a template, or forwarding it through an external communication service. When the user chooses to send the document, the terminal transmits the necessary metadata such as recipient and subject back to the server or to a mail-delivery service, which then sends the document as an electronic message.
   The system improves computer technology by structuring the generative AI model interaction into a multi-stage, feedback-driven pipeline that is implemented and enforced at the processor level. Because the server automatically performs grammar and spelling correction, tone adjustment, and style harmonization using specific algorithms and structured editing instruction information, the server reduces the need for repeated full-text regeneration and manual edits. This leads to fewer calls to the generative AI model and more efficient use of compute resources on the accelerator device. By recording and exploiting association information between prompts, criteria, and outputs, the server adapts prompts over time in a way that reduces error rates and processing time. The technical improvement lies in the coordinated control of the model, the data structures for recording intermediate states, and the specific algorithms for automatic correction and adjustment, instead of mere automation of a human editing workflow.
   The server further improves memory and data management by maintaining explicit links between input character information, intermediate documents, detected errors, and final outputs. This enables efficient querying and reuse of prior results, such as reapplying previously effective editing instruction patterns to similar future documents. The system thus reduces redundant processing and improves cache hit rates in storage and model-serving layers, which contributes to reduced latency and lower energy consumption.
   The server processes user emotion information and criterion information in a machine-interpretable manner and translates them into explicit editing instruction information. This is fundamentally different from human editing or simple parameter toggling because the server implements a defined mapping from quantitative or categorical emotional features to tone and style parameters that are embedded into model prompts and, if needed, into auxiliary control vectors supplied to the generative AI model. In one variation, the server attaches an additional conditioning vector to the input token sequence, representing tone and emotional constraints learned during training by treating them as labels in a multi-task learning setup. This allows the generative AI model to modify its internal attention patterns and output distribution in a technical way that directly affects token selection, rather than merely copying human instructions. Such a mechanism improves the precision of tone control and reduces the need for post-generation filtering.
   In alternative embodiments, the server may execute the generative AI model locally on its own accelerator hardware, or may distribute the model across multiple machines for parallel inference. The server can also use different neural network architectures, such as encoder-only transformers or hybrid models that combine rule-based preprocessing with neural generation. The server may adjust hyperparameters such as temperature, top-k sampling, or beam search width dynamically based on recorded association information to achieve desired trade-offs between diversity and determinism in the generated communication document. In other embodiments, the terminal may perform part of the analysis or emotion detection locally and transmit only processed feature vectors to the server, thereby reducing bandwidth usage and enhancing privacy. In another variation, the system can be integrated with specialized hardware modules for biometric sensing, where the terminal acquires biological measurement information and sends reduced data representations to the server. The server then integrates these representations into the emotion evaluation process described above.
   By combining structured prompt construction from list-format information, multi-stage document refinement, explicit storage of intermediate and association information, and systematic interpretation of user emotion and criteria into editing instruction information, the system provides a concrete, technical improvement to how computing devices generate and manage communication documents using a generative AI model. This improvement manifests as lower error rates in final documents, faster convergence to acceptable outputs with fewer model invocations, reduced network communication volume, and enhanced traceability and controllability of text-generation behavior at the level of computer architecture and data structures, rather than as a mere automation of human writing tasks.

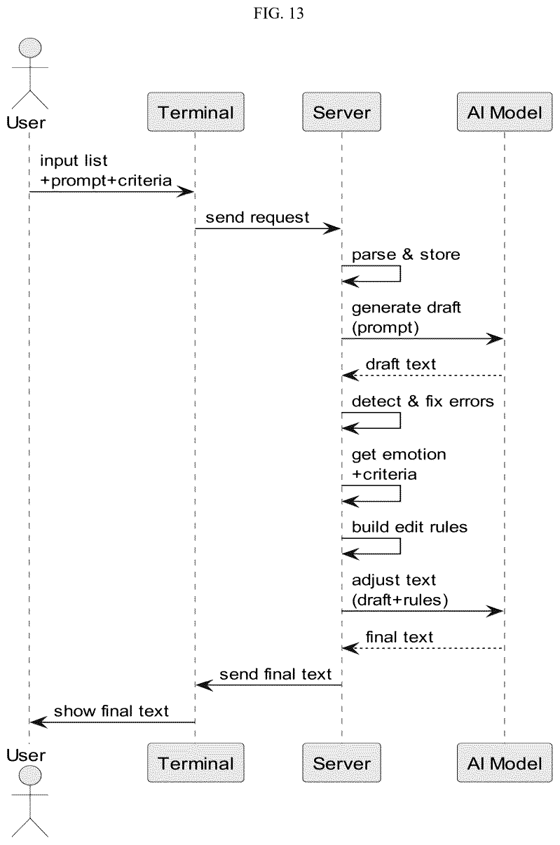

The following describes the processing flow using FIG. 13.

### Step 1:

The user operates the terminal to start an application that provides a text input interface. The terminal displays an input area for list-format information and a separate input area for a prompt sentence, together with selectable options for criterion information such as tone, length, and style. The user inputs list-format information, for example, a set of bullet points describing product features and target customers, and inputs a prompt sentence such as “Please create an email to announce the release of a new cloud service to our enterprise customers. Emphasize scalability and cost savings.” The user selects criterion information such as “tone=formal” and “length=medium.” The terminal receives these inputs, combines them into structured request data, validates the presence of mandatory fields, and prepares a transmission payload. As input, the terminal uses user-entered character information and selected criteria; as output, the terminal produces a structured data object that encodes the list items, the prompt sentence, and the criterion information.

### Step 2:

The terminal transmits the structured request data to the server over a network using a secure communication protocol. The terminal serializes the prompt sentence, the list-format information, user identifier, and criterion information into a message and sends the message to a predefined server endpoint. The terminal may add a timestamp and a request identifier before transmission. As input, the terminal uses the structured data object prepared in Step 1; as output, the terminal sends a network message and receives an acknowledgement from the server indicating successful receipt.

### Step 3:

The server receives the network message containing the structured request data from the terminal. The server parses the message to extract the prompt sentence, the list-format information, and the criterion information. The server validates the data types and checks for missing fields and malformed characters. The server then writes the raw input data into persistent storage, associating it with a newly generated request identifier. As input, the server uses the serialized network message; as output, the server produces normalized internal representations for the prompt sentence, list items, and criteria, and stores them as database records.

### Step 4:

The server analyzes the list-format information in the character data to construct an internal structured representation. The server tokenizes each list item into words or subword units using a text-processing library and detects list boundaries based on bullet markers or numbering. The server converts each list item into a sequence of tokens and associates an index with each item. The server aggregates these token sequences into a list data structure that preserves item order and category labels, such as “features” or “constraints,” if such labels are present in the user input. As input, the server uses the list-format text extracted in Step 3; as output, the server generates an internal list representation suitable for further processing and prompt construction.

### Step 5:

The server constructs a model-facing prompt sentence for the generative AI model by combining the internal list representation, the original user prompt sentence, and the criterion information. The server applies predetermined rules to embed each list item into labeled sections in the prompt, such as “Key points:” followed by bullet points, and appends explicit instructions for tone, length, and style. The server also includes task-specific guidance such as “Generate a complete business email.” The server concatenates these components in a predefined order and normalizes the text encoding. As input, the server uses the original prompt sentence, the tokenized list items, and the criterion information; as output, the server produces a single, coherent prompt sentence that will be passed to the generative AI model.

### Step 6:

The server invokes the generative AI model with the constructed prompt sentence. The server sends the prompt sentence to a model-serving interface, which may be a local or remote service hosting a transformer-based neural network. Internally, the model tokenizes the prompt sentence, maps tokens to embeddings, applies multiple layers of attention and feed-forward operations, and computes output token probabilities. The server waits for the model to return a sequence of output tokens representing a draft communication document and then decodes these tokens into text. As input, the server uses the constructed prompt sentence from Step 5; as output, the server obtains a generated draft communication document in text form.

### Step 7:

The server stores the generated draft communication document as intermediate information associated with the request identifier and the original prompt sentence. The server writes the draft document, together with metadata such as the model version and timestamp, into the database. The server also logs the fact that a generation process has completed. As input, the server uses the text of the draft communication document and the request identifier; as output, the server produces updated database records that preserve the first version of the document and its generation context.

### Step 8:

The server performs automatic error detection on the draft communication document. The server applies a character-string analysis algorithm that uses tokenization, dictionary lookup, and edit-distance computation to identify spelling errors and typographical errors. The server additionally applies a language-structure analysis algorithm, such as a part-of-speech tagger and dependency parser, to detect grammatical inconsistencies, including subject-verb disagreement and incorrect tense. The server marks error positions and generates error information and grammatical error information for each detected issue. As input, the server uses the draft communication document from Step 7; as output, the server produces annotated error data and an error-marked version of the document.

### Step 9:

The server corrects the draft communication document based on the detected error information and grammatical error information. The server replaces erroneous words with candidate corrections selected by comparing edit distances and dictionary frequencies, and rewrites grammatically incorrect segments according to predefined transformation rules or using an auxiliary call to the generative AI model with an instruction to maintain meaning while fixing grammar. The server then reconstructs a corrected communication document without the original errors. As input, the server uses the original draft document and the error annotations produced in Step 8; as output, the server generates a corrected communication document and updates the processing history to record the specific corrections applied.

### Step 10:

The server evaluates emotion information for the user and combines it with the stored criterion information. The server retrieves operation information (such as keystroke patterns or response times) and any available biological measurement information or self-report information from the terminal or from prior records. The server converts these raw signals into feature vectors and applies an emotion classification algorithm, such as a trained neural network or statistical classifier, to determine an emotional state category (for example, calm, stressed, or urgent). The server merges the emotional state category with the criterion information to form a combined profile of user-related constraints. As input, the server uses the operation and emotion-related signals and the criterion information; as output, the server produces emotion information and a combined user profile for use in tone and style adjustment.

### Step 11:

The server generates editing instruction information based on the emotion information and the criterion information. The server maps the emotional state and criteria to concrete tone and style parameters, such as desired sentence length, level of formality, politeness level, and vocabulary restrictions. The server encodes these parameters in a structured format, for example, a key-value map indicating “tone=formal,” “politeness=high,” “technical_terms=limited,” and “length=medium.” The server then associates this editing instruction information with the corrected communication document. As input, the server uses the combined user profile from Step 10; as output, the server produces editing instruction information that can be applied to rewrite the communication document consistently.

### Step 12:

The server adjusts the corrected communication document by invoking the generative AI model with the editing instruction information. The server constructs a new prompt sentence that embeds both the corrected communication document and explicit instructions reflecting the editing instruction information, such as “Rewrite this email to be formal, concise, and polite, while avoiding technical jargon.” The server sends this new prompt sentence and the corrected document to the generative AI model. The model processes the text and produces an adjusted communication document where word choice, sentence structure, and overall tone conform to the editing instructions. As input, the server uses the corrected communication document and the editing instruction information; as output, the server obtains an adjusted communication document whose tone and style have been systematically modified.

### Step 13:

The server records the adjusted communication document and the full processing history as recording information. The server stores intermediate versions of the document (initial draft, corrected version, and adjusted version), the associated prompts, the error and grammar annotations, and the editing instruction information, all linked by the request identifier. The server logs timestamps and identifiers of algorithms and model instances used in each stage.
As input, the server uses all generated document versions and metadata from previous steps; as output, the server produces a comprehensive set of database entries that make the generation, correction, and adjustment procedure traceable.

### Step 14:

The server prepares a response payload containing the adjusted communication document and optional metadata, such as the applied tone and style information, and returns this payload to the terminal over the network. The server may additionally include a summary of transformations, such as the number of corrections performed or the type of tone adjustment applied. As input, the server uses the final adjusted communication document and the associated metadata; as output, the server produces a serialized response message addressed to the originating terminal.

### Step 15:

The terminal receives the response payload from the server and parses the content to extract the adjusted communication document and any additional metadata. The terminal displays the adjusted communication document in a user-editable text area on the display. The terminal may also show indicators of the selected tone or other criteria so that the user can understand how the document has been shaped. As input, the terminal uses the response message from Step 14; as output, the terminal renders the document on the display and provides it as an editable text object for the user.

### Step 16:

The user reviews the adjusted communication document presented on the terminal and optionally performs manual edits using the keyboard or touch interface. The user may change specific phrases, adjust the subject line, or insert additional information that is specific to a current context. When the user is satisfied, the user instructs the terminal to save or send the document. As input, the user uses the displayed document and the editing capabilities of the terminal; as output, the user produces a finalized version of the document and a corresponding command (for example, a send command) that the terminal can process.

### Step 17:

The terminal processes the user's command to save or send the finalized document. If the user requests saving, the terminal stores the finalized document locally or notifies the server to update the stored version. If the user requests sending, the terminal collects additional transmission parameters, such as recipient address and subject, and packages them with the finalized document. The terminal then forwards this package to the server or to an external communication service for delivery. As input, the terminal uses the finalized document and the user-specified transmission parameters; as output, the terminal produces a transmission request that completes the workflow of generating, refining, and utilizing the communication document created with the generative AI model based on the initial prompt sentence.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional computer-implemented authoring systems for business communications merely accept free-form text or templates and then perform simple text generation or spell checking. Such systems do not deeply integrate natural language processing, generative artificial intelligence models, and emotion analysis into a unified control loop at the processor level. As a result, several technical problems arise in the operation of the computing environment itself.

First, the processor typically receives heterogeneous, low-structure input such as bullet-point lists and user preferences, and must construct suitable inputs for a generative AI model. Existing systems commonly pass such input directly as raw text to the model, which forces the model to perform all contextualization internally. This leads to unstable generation behavior, increased token usage, and repeated model invocations, thereby increasing processing load on the processor, network traffic to remote inference services, and overall latency of the system.
Second, confirmation and correction of generated business documents are often implemented as separate, loosely coupled tools. A generated text is exported to an external grammar checker or is manually corrected, and then re-imported for further processing. This fragmented workflow hinders automated end-to-end processing within the processor, causes additional input/output operations between applications, and prevents the processor from effectively reusing intermediate analysis results. Consequently, the computing resources such as CPU cycles, memory bandwidth, and network bandwidth are not efficiently utilized.
Third, conventional systems only weakly incorporate user emotion or recipient behavior into the generation pipeline. When emotion analysis is used at all, it is typically applied only to the final text or as a post-hoc metric, without feeding back the analysis results into the prompt design or into adaptive weighting of model control parameters. As a result, the processor does not maintain a closed feedback loop between emotion state estimation, prompt construction, generative model control, and subsequent revisions. This lack of integration reduces the predictability of output tone and style, and requires additional manual corrections by the user, increasing interaction rounds and server-terminal communication overhead.
Fourth, existing systems do not learn from user-side editing operations at the level of system control logic. User edits are generally stored as new versions of documents, but are not used to automatically update prompt generation rules or emotion weighting parameters. Therefore, the processor must repeatedly execute expensive generative and corrective operations even for similar tasks for the same user, which degrades responsiveness and causes redundant computation.
The technical problem to be solved is to improve the operation of the computer system itself by providing a processor-controlled architecture that: (i) converts bullet-point input into a structured, optimized prompt sentence; (ii) tightly integrates grammar correction, emotion analysis, and generative AI model control in a unified processing pipeline; (iii) dynamically adjusts model prompts and document structure based on user emotion, preset criteria, and recipient history; and (iv) incrementally updates internal generation rules based on user editing behavior, thereby reducing redundant processing and improving latency, resource efficiency, and consistency of machine-generated business communications.

The specific processing by the specific processing unit 290 of the data processing device 12 in Application Example 2 is realized by the following means.

The present invention provides a server comprising a processor configured to receive, from a terminal, information in a bullet-point format and user criteria, to analyze the information by using a natural language processing module, and to construct a structured prompt sentence for instructing a generative AI model to generate business-related information; a communication interface configured to transmit the constructed prompt sentence to the generative AI model and to receive, from the generative AI model, generated business-related information; a verification module configured to automatically check the generated business-related information by using a character string analysis algorithm and a syntactic analysis algorithm and to correct typographical errors and grammatical errors in the generated business-related information; an emotion analysis module configured to evaluate a user emotional state based on user input or external information; a control module configured to generate, on the basis of the evaluated user emotional state and user-preset criteria, an updated prompt sentence including additional control input for adjusting a tone and a style of the business-related information, and to instruct the generative AI model to modify or regenerate contents of the business-related information; an optimization module configured to analyze past response history information associated with a recipient and to adjust the prompt sentence so as to optimize structural elements of the business-related information including a subject portion, an introduction portion, and a call-to-action portion; a learning module configured to acquire editing operation content applied by the user to the business-related information and, on the basis of the editing operation content, to update prompt generation rules and weighting conditions of the emotion analysis module; and an output interface configured to output the tone-adjusted and style-adjusted business-related information to the terminal and, in response to a transmission instruction from the terminal, to perform transmission processing of the business-related information by using a transmission control scheme. This enables the server to implement an integrated, feedback-driven control loop for generative AI-based document creation, in which prompt construction, grammar correction, emotion-based adjustment, recipient-based optimization, and user-preference learning are executed coherently within the processor, thereby reducing redundant model invocations, lowering computational and communication overhead, and improving latency, stability, and consistency of computer-generated business communications.

The term “business-related information” refers to character data representing a message, document, or other textual content used for commercial or organizational communication, including but not limited to electronic mail content, notifications, and proposals.

The term “bullet-point format” refers to an input representation in which multiple items are listed as separate short text segments, phrases, or sentences, each indicating a point, topic, or element to be reflected in a generated document.
The term “natural language processing module” refers to a software component executed by a processor that analyzes text in a human language by performing at least one operation among tokenization, part-of-speech tagging, syntactic parsing, named entity recognition, or semantic analysis.
The term “prompt sentence” refers to a sequence of character data in natural language that is constructed to instruct a generative AI model regarding a generation task, including constraints on content, tone, structure, and style of output text.
The term “generative AI model” refers to an information processing model that, in response to a prompt sentence, generates new text data by probabilistically predicting output tokens based on a parametrized language model.
The term “communication interface” refers to a hardware and/or software entity that performs data transfer between a server and an external apparatus over a communication network using a communication protocol.
The term “character string analysis algorithm” refers to a processing procedure that examines sequences of characters to detect and optionally correct errors such as misspellings, invalid tokens, or inconsistent spacing.
The term “syntactic analysis algorithm” refers to a processing procedure that determines grammatical structure of an input sentence, including relationships among words or phrases, in order to detect grammatical errors or inconsistencies.
The term “typographical errors” refers to unintended deviations in character sequences, including misspellings, missing characters, extra characters, transposed characters, and incorrect punctuation.
The term “grammatical errors” refers to violations of grammatical rules of a target language, including incorrect inflection, agreement, word order, or use of function words.
The term “emotion analysis module” refers to a software component that estimates an emotional state associated with a user or text by applying at least one of statistical methods, rules, or machine learning models to input data.
The term “user emotional state” refers to an internal affective condition of a user, represented within the system as one or more emotion labels, intensities, or scores such as joy, frustration, satisfaction, or anxiety.
The term “user-preset criteria” refers to configuration data specified in advance by a user, defining desired properties of generated content, including at least one of tone, style, politeness level, length, and structural preference.
The term “control module” refers to a software component that coordinates operations of other modules, including generation of prompt sentences, invocation of the generative AI model, and adjustment of generated content in response to emotion analysis and user-preset criteria.
The term “tone” refers to a stylistic attribute of text expressing an attitude or manner of expression, such as formal, informal, apologetic, or enthusiastic.
The term “style” refers to a set of textual characteristics including diction, sentence structure, level of detail, and formality, which together determine the overall manner of presentation of content.
The term “modify or regenerate contents” refers to an operation in which existing generated text is either revised in part or discarded and newly generated, in response to an updated prompt sentence or additional control information.
The term “terminal apparatus” refers to an information processing device operated by a user, such as a computing device, a communication device, or a display device, that transmits input data to the server and receives output data from the server.
The term “transmission control scheme” refers to a procedure or protocol by which electronic messages are delivered from the server to a destination, including but not limited to electronic mail protocols or messaging protocols.
The term “past response history information” refers to stored data indicating reactions or behaviors of a recipient to previous communications, including at least one of open events, reply events, click events, or delivery failures.
The term “structural elements” refers to functional segments of a document, including but not limited to a subject portion, an introduction portion, a body portion, and a call-to-action portion.
The term “subject portion” refers to a text segment that summarizes or titles a communication, typically used as a header field in an electronic message.
The term “introduction portion” refers to a text segment that appears at a beginning of a document and provides initial context, greeting, or purpose of the communication.
The term “call-to-action portion” refers to a text segment that explicitly invites, requests, or encourages a recipient to perform a particular action, such as replying, clicking a link, or making a purchase.
The term “editing operation content” refers to information describing operations performed by a user to change a generated document, including insertions, deletions, replacements, and reordering of text.
The term “prompt generation rules” refers to internal configuration data and logic that define how input information, user criteria, and analysis results are combined to construct a prompt sentence.
The term “weighting conditions of the emotion analysis module” refers to parameters or coefficients that determine influence of different emotion-related features or signals on decisions regarding prompt construction or content adjustment.
The term “preferences of the user” refers to tendencies or patterns in desired output characteristics inferred from configuration settings and editing operation content for the user.

In one embodiment, a server, a terminal, and a user cooperate to implement the claimed system. The server includes at least one processor, a memory, a non-transitory storage medium, and a network interface. The terminal includes an input unit, a display unit, a communication unit, and a local processor. The user operates the terminal to provide input and to confirm or edit generated content.

The server executes an operating system such as a general-purpose server operating system and application software written in a programming language such as a scripting language or a high-level compiled language. The server further executes a natural language processing module implemented with a library such as a statistical or neural NLP toolkit, a generative AI client module configured to access a remote generative AI model (for example, a transformer-based language model exposed via an HTTP-based API), a grammar checking module implemented with a rule-based or machine-learned grammar engine, an emotion analysis module implemented with a classifier such as a neural network text classifier, an optimization module implemented with a machine learning framework such as a numerical computation library, and a learning module that updates configuration data stored in the storage medium.
The terminal executes a user interface application such as a web browser or a native client application. The terminal provides graphical controls for the user to input bullet-point information, to specify tone and style preferences, and to trigger generation, correction, and transmission operations. The terminal uses a secure communication protocol such as HTTPS over TLS to transmit user input to the server and to receive generated business-related information from the server.
The user inputs bullet-point information and user-preset criteria through the terminal. The bullet-point information may consist of short natural language fragments that represent key points to be included in a business-related message, such as:
“new product launch”
“special discount”
“limited-time campaign”
   The user also inputs criteria such as:
“Tone: formal”
“Language: English”
“Purpose: introduction of new product to a business partner”
   The terminal normalizes this input in a structured representation and transmits the representation to the server via the network interface.
   The server stores the received representation in the memory and passes it to the natural language processing module. The natural language processing module uses tokenization algorithms, part-of-speech tagging, syntactic parsing, and named entity recognition to convert the bullet-point information into structured internal records. For example, the server assigns each bullet point an identifier, a list of tokens, part-of-speech tags, and entity labels such as “product,” “time limitation,” or “promotion.” The server stores these records in data structures such as lists of objects or records, which are cached in working memory for subsequent operations.
   The server then constructs a prompt sentence for a generative AI model. The server uses the structured records and user-preset criteria to assemble a natural language instruction string according to prompt generation rules stored in the storage medium. These rules may specify, for example, that the prompt sentence must contain: (i) an explicit enumeration of bullet points, (ii) a description of the intended audience, (iii) a specification of tone and language, and (iv) an explicit request for structure (such as introduction, body, and closing). An example of a constructed prompt sentence is:
   “The following bullet points describe a marketing email:
1. new product launch
2. special discount
3. limited-time campaign
   Please use these points to write a formal business email in English introducing the new product to a business partner. Start with a polite greeting, briefly describe the product and the discount, mention that the campaign is limited-time, and end with a courteous closing. Keep the tone professional and respectful.”
   The server transmits this prompt sentence to a generative AI model via the generative AI client module. In one implementation, the generative AI model is a transformer-based language model running on an external inference platform. The model includes a plurality of transformer layers, each transformer layer including a multi-head self-attention sub-layer and a position-wise feed-forward sub-layer. The model stores trainable parameters such as weight matrices for attention, projection, and feed-forward operations. The server sends the prompt sentence as an input sequence of tokens, and the generative AI model outputs a sequence of tokens representing a candidate business-related document.
   The server receives the generated token sequence and decodes it into a character string. The server stores this string in the memory as raw generated text. To improve correctness, the server applies a grammar checking module that includes at least one syntactic analysis algorithm and at least one character string analysis algorithm. The syntactic analysis algorithm may use a dependency parser to detect subject-verb mismatches, incorrect clause structures, or invalid word orders. The character string analysis algorithm may use edit distance measures, dictionary lookups, and statistical n-gram scoring to identify typographical errors. The server applies corrections directly to the character string, producing a corrected version of the generated text.
   The server then invokes the emotion analysis module. In one embodiment, the emotion analysis module employs a text classification model based on a neural network such as a bidirectional encoder or a transformer encoder. The model has been trained on labeled datasets of text with emotion labels such as “joy,” “anger,” “frustration,” or “satisfaction.” The server provides either the original user input (such as the user's free-form instruction) or external information (such as a customer's inquiry) as input to the emotion analysis model. The model processes input tokens through embedding, positional encoding, multi-head attention, and feed-forward layers, and outputs a probability distribution over emotion categories. The server interprets the category with the highest probability as the user emotional state and stores an emotion label and a confidence score.
   The server uses the evaluated emotional state and the user-preset criteria to generate an updated prompt sentence for content adjustment. For example, if the user-preset criteria specify a formal tone and the emotion analysis module determines that a customer is frustrated, the server constructs a prompt sentence such as:
   “The customer's emotion is frustration. Please revise the following email to use a formal and apologetic tone, clearly acknowledging the issue and promising quick resolution, while remaining respectful and concise:
[existing email text]”
   The server then transmits the updated prompt sentence and the existing email text to the generative AI model. The generative AI model again processes the input and generates a revised email. The server may apply an additional grammar check to the revised email and then stores the result as final business-related information.
   In another embodiment, the server further includes an optimization module that analyzes past response history information of a recipient. The server maintains, in a structured database, records of previous communications, including subject lines, key content features, and recipient behaviors such as opens, clicks, or replies. The optimization module uses a supervised learning algorithm, such as logistic regression, gradient boosting, or a shallow neural network implemented in a numerical computing framework, to estimate which structural elements (such as length of the subject line, presence of a specific phrase in the introduction, or positioning of a call-to-action phrase) are correlated with higher engagement for a given recipient segment. The server retrieves the relevant history data, applies feature extraction to convert text into numerical features (for example, counts of certain token categories or semantic features), and computes prediction scores. The server adjusts the prompt sentence parameters using these scores, for example by specifying that the subject line should emphasize a time-limited offer or that the introduction should be shortened. This targeted adjustment leads to a more efficient generative invocation, because the generative AI model receives a more constrained and optimized instruction, reducing the need for repeated trial-and-error generations.
   The server also implements a learning module that updates prompt generation rules and emotion weighting conditions based on user editing operations. When the user edits a generated email on the terminal, the terminal sends an edit log to the server. The edit log may include the original text, the edited text, and actions such as “insert,” “delete,” “replace,” or “reorder.” The server computes differences between original and edited content, detects patterns such as “user consistently shortens introductions” or “user consistently strengthens apologies under frustration emotion,” and updates internal parameters. The server may use a reinforcement learning scheme or an online learning algorithm to adjust weights in the prompt generation rules. For example, the server assigns a higher weight to features that align with user corrections and reduces weight for features that consistently cause user edits. Over time, this process reduces the divergence between generated text and user preference, leading to fewer corrections required by the user and therefore fewer round trips between the terminal and the server.
   The server uses these modules together to implement a feedback-controlled generation pipeline that improves underlying computer operations. Because the server constructs structured prompt sentences using explicit NLP analysis, the input to the generative AI model is more precise, which reduces the average number of tokens and decreases computational load on the remote inference platform. Because grammar checking and emotion analysis are integrated within the same processor pipeline, intermediate representations such as parse trees and token sequences can be reused, reducing redundant computations and memory transfers. Because recipient behavior analysis directly drives structural optimization of generated documents, the server can avoid multiple failed attempts and instead perform a single generation with higher relevance, thereby decreasing network calls and latency. Because user editing data are used to adapt prompt generation rules at the system level, the server reduces future editing overhead and improves convergence of output characteristics.
   The generative AI model used by the server may be trained in advance with a large corpus of text using a self-supervised learning objective such as next-token prediction or masked-language modeling. During training, the model receives tokenized sequences, computes predicted token distributions via softmax activation over vocabulary logits, and updates weights using backpropagation and a loss function such as cross-entropy. The training procedure may incorporate regularization techniques such as dropout and layer normalization, and data augmentation such as random masking of tokens. Although training generally occurs on a separate training infrastructure, the server is configured to interact with the trained model via a defined API, and the design of prompt sentences is adapted to the architecture of the transformer network, for example by controlling input length and structure for efficient attention computation.
   In some variations, the server may host the generative AI model locally. In this case, the server loads model parameters into memory, uses a hardware accelerator such as a graphics processing unit or tensor processing unit, and directly performs matrix multiplications and non-linear activation functions during inference. The server may maintain multiple versions of the model with different sizes and switch between them based on input complexity to further optimize computational resources and response latency.
   In another embodiment, the emotion analysis module may also be implemented as a transformer encoder trained with a supervised objective on emotion labels. The server may fine-tune the model using domain-specific data, controlling learning rate, weight decay, and batch size to balance generalization and responsiveness. The learning module may periodically trigger fine-tuning sessions using accumulated edit logs and new emotion annotations to refine both the emotion classifier and the prompt generation rules.
   The technical effect of this architecture is not limited to automation of human writing tasks. The server improves operation of the underlying computer system by reducing CPU cycles and network transfers through more efficient prompt construction, by decreasing storage usage through consolidation of intermediate representations, and by improving cache locality through unified processing of NLP, grammar, and emotion analysis in shared data structures. The feedback loop between emotion analysis, recipient behavior analysis, and generative control reduces the need for manual corrections and repeated generations, thereby lowering end-to-end latency and improving throughput under high load. These improvements arise from concrete algorithmic structures, data structures, and control flows executed by the processor, and not merely from execution of an abstract business rule.
   The terminal displays the final or intermediate business-related information to the user. The user may inspect, approve, or further edit the text. When the user instructs the terminal to transmit the email or other message, the terminal sends a transmission instruction to the server. The server assembles the final document into a message structure and passes it to a messaging subsystem that uses a standardized transmission control scheme such as a mail transfer protocol or another communication protocol. The server logs message identifiers, timestamps, and status codes in persistent storage to facilitate monitoring, debugging, and future optimization.
   In alternative embodiments, the server may support different languages, domains, and document types by switching between different prompt generation profiles, different grammar rule sets, and different emotion label taxonomies. The core architecture, however, remains centered on the processor-controlled generation and refinement pipeline: structured prompt sentence construction based on bullet-point input, integrated grammar and emotion analysis, adaptive adjustment of generative control parameters, recipient behavior-based optimization, and user editing-driven learning. This architecture allows other skilled persons to implement the invention on various hardware and software platforms while preserving the technical advantages described above.

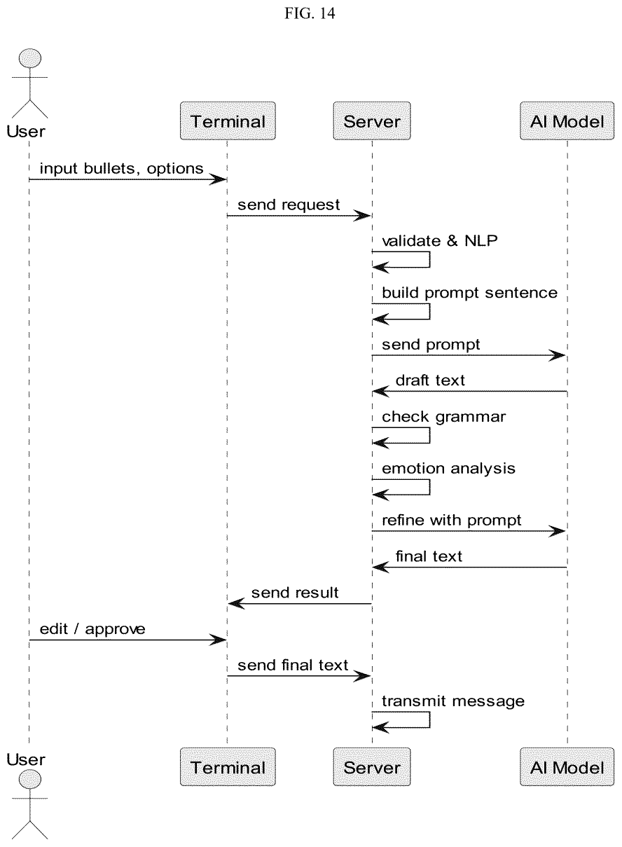

The following describes the processing flow using FIG. 14.

### Step 1:

The user operates the terminal to input bullet-point information and criteria.
The user enters multiple short text items such as “new product launch”, “special discount”, and “limited-time campaign” into input fields, and selects options such as “Tone: formal”, “Language: English”, and “Purpose: introduction of new product to a partner”.
The input is a set of raw character strings and option selections. The terminal converts these into a structured internal representation, for example a list of bullet items and a key-value map of criteria, and stores this representation in local memory as the output of this step.

### Step 2:

The terminal transmits the structured input to the server over a secure channel.
The terminal packages the bullet items and criteria into a request message, opens an HTTPS connection using a communication unit, and sends the message to a predefined API endpoint of the server.
The input is the structured representation created in Step 1. The terminal serializes this data into a message format (for example, JSON over HTTP), applies encryption via a transport layer security protocol, and outputs an encrypted network packet stream that is delivered to the server.

### Step 3:

The server receives and validates the transmitted input.
The server, via its network interface, accepts the HTTPS request, decodes the encrypted stream, and passes the request body to an application framework. The server checks that bullet items are present, that each item is a non-empty string, and that tone and language values match allowed sets.
The input is the serialized request message from the terminal. The server parses this into native data structures, performs validation checks such as type checking and range checking, and outputs a validated internal object containing bullet items and user criteria.

### Step 4:

The server performs natural language pre-processing on the bullet items.
The server invokes a natural language processing module to tokenize each bullet item, assign part-of-speech tags, detect named entities, and compute basic syntactic relations. The server may also normalize forms, such as converting plural nouns to singular lemmas.
The input is the validated internal object from Step 3. The server runs NLP algorithms over each text string, producing for each bullet a record including tokens, lemmas, tags, and entity labels. The output is a set of structured bullet records ready for prompt construction.

### Step 5:

The server constructs a prompt sentence for a generative AI model.
The server applies prompt generation rules that specify how to assemble bullet records and criteria into a coherent instruction. The server concatenates bullet texts into a numbered list, inserts tone and language constraints, and appends explicit structural instructions.
The input is the set of structured bullet records and the user criteria from Step 4. The server performs string concatenation, template filling, and rule-based reordering to produce a single natural-language prompt sentence. The output is a character string such as:
“The following bullet points describe a marketing email:
1. new product launch
2. special discount
3. limited-time Campaign
   Please use these points to write a formal business email in English introducing the new product to a business partner. Start with a polite greeting, briefly describe the product and the discount, mention that the campaign is limited-time, and end with a courteous closing. Keep the tone professional and respectful.”

### Step 6:

The server sends the prompt sentence to the generative AI model and requests text generation.
The server passes the prompt sentence to a generative AI client module, which formats the sentence into an API request, sets model parameters such as maximum output length and sampling temperature, and transmits the request to a transformer-based language model running on an inference platform.
The input is the constructed prompt sentence from Step 5. The server encodes the prompt into tokens, sets numerical hyperparameters, and outputs a network request containing these tokens and parameters, which is sent to the generative AI model.

### Step 7:

The server receives and decodes a generated document from the generative AI model.
The server obtains the model response, which includes a sequence of output tokens representing the generated business-related document. The server decodes the tokens into characters using a vocabulary mapping and joins them into text lines.
The input is the model response packet delivered over the network. The server performs token-to-text mapping and removes any extraneous control tokens, and outputs a raw generated text string such as a complete email body.

### Step 8:

The server performs grammar and spelling correction on the generated text.
The server invokes a grammar checking module and a character string analysis algorithm.
The server segments the text into sentences, parses each sentence to detect agreement errors or invalid constructions, and runs a spelling checker that compares tokens with lexicon entries and computes edit distances to suggest corrections.
The input is the raw generated text from Step 7. The server applies multi-stage analysis: sentence splitting, syntactic parsing, error detection, and replacement of erroneous tokens or structures. The output is a corrected text string in which typographical errors and grammatical errors have been modified to conform to language rules.

### Step 9:

The server evaluates a user or customer emotional state.
The server passes either the initial user instructions, the customer inquiry content, or both to an emotion analysis module. The server tokenizes this input text, forms embedding vectors, processes them through a neural network classifier, and receives a probability distribution over emotion classes.
The input is one or more text segments associated with the communication context. The server executes forward propagation through the classifier, computes softmax probabilities, and outputs an emotion label such as “frustration” or “joy” together with a confidence score.

### Step 10:

The server generates an updated prompt sentence for tone and style adjustment.
The server combines the corrected text from Step 8, the emotion label from Step 9, and the user-preset criteria into an extended instruction. The server explicitly states the detected emotion and desired tone and instructs the generative AI model to revise or regenerate content accordingly.
The input is the corrected document text and metadata (emotion and criteria). The server applies rule-based templates and inserts variables such as emotion label and tone setting, producing an updated prompt sentence, for example:
“The customer's emotion is frustration. Please revise the following email to use a formal and apologetic tone, clearly acknowledging the issue and promising quick resolution, while remaining respectful and concise:
[existing email text]”
The output is this updated prompt sentence encoded as a character string.

### Step 11:

The server refines the generated document using the updated prompt sentence.
The server sends the updated prompt sentence and the existing document text to the generative AI model again. The model processes both the instruction and the original text to yield a revised version that better matches the specified tone and emotion. The server decodes the response to obtain the revised document.
The input is the updated prompt sentence and the existing corrected document from Step 10.
The server re-invokes the generative AI client module, transmits the combined input, and receives a new sequence of tokens. The output is a refined text string that incorporates tone and emotion adjustments.

### Step 12:

The server optionally optimizes document structure using recipient history.
The server queries stored records of past messages and observed recipient behavior metrics.
The server computes features such as subject length, number of calls-to-action, and introductory paragraph length, and applies a predictive model to estimate which structural choices will maximize engagement.
The input is the refined text from Step 11 and recipient history data from persistent storage.
The server performs feature extraction and model inference, then rewrites structural elements such as the subject line, introduction, or call-to-action segment by applying deterministic rules or minor regeneration prompts. The output is an optimized version of the document structure.

### Step 13:

The server applies user-preference learning based on editing logs.
The server retrieves recent editing operations submitted by the user for similar documents, compares original and edited segments, and calculates statistics indicating recurring changes (for example, consistent shortening of openings or strengthening of apologies).
The input is a set of historical edit logs and the current document properties. The server computes alignment between current generation and past edits, updates weights in prompt generation rules and emotion weighting functions, and outputs updated internal parameters that will influence future prompt construction and tone control.

### Step 14:

The server sends the finalized document to the terminal for preview.
The server packages the optimized, corrected, and tone-adjusted document, including subject and body, into a response message and transmits it over HTTPS to the terminal. The server may also include meta-information such as detected emotion and applied tone.
The input is the final document text resulting from Steps 8 to 12. The server inserts this text into a response structure, encodes it, and outputs a network response that the terminal can decode and display.

### Step 15:

The terminal displays the finalized document and accepts user edits or approval.
The terminal renders the subject and body in an editable area of the user interface. The user can scroll through the text, modify phrases, and either approve the content or continue editing.
The input is the response message from the server containing the final document. The terminal decodes the message, maps content to UI components, and outputs a visual representation plus any further text edits generated by user interaction.

### Step 16:

The terminal transmits a send instruction and any user modifications to the server.
The terminal collects the final edited text from the user interface, along with a flag indicating whether the user has chosen to send the message or save it as a draft, and sends this information back to the server.
The input is the user-edited subject and body and the user's action selection. The terminal serializes this data into a control request, applies secure transport, and outputs a control message that instructs the server how to handle the final document.

### Step 17:

The server performs transmission processing of the finalized document.
The server receives the control message, updates any stored draft with the user's edits, and, when instructed to send, constructs an electronic message including appropriate headers and the finalized content. The server then uses a transmission control scheme to deliver the message to a destination address.
The input is the finalized content and the send instruction from Step 16. The server formats the message, interacts with a messaging subsystem or protocol to perform handshaking, authentication, and data transfer, and outputs a delivery result status that can later be reported to the terminal.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naive Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

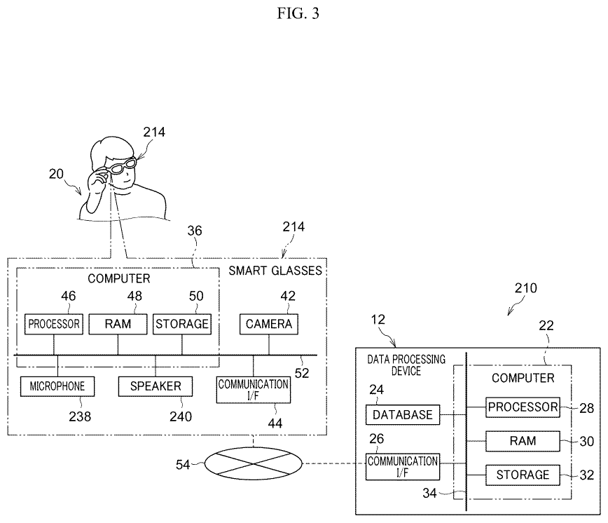

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

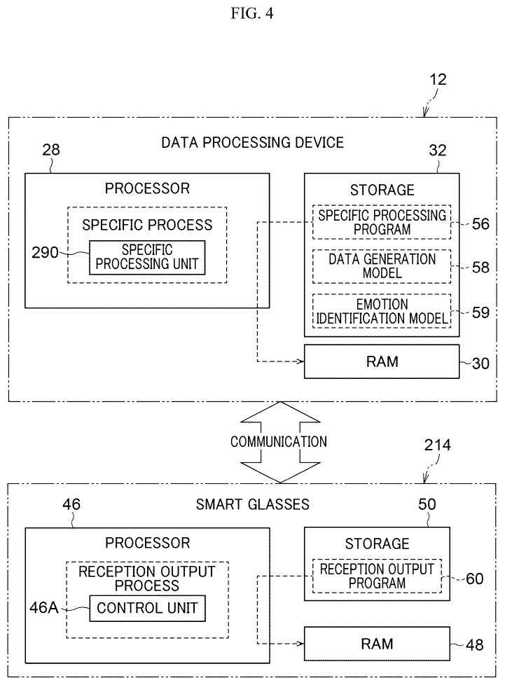

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naive Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

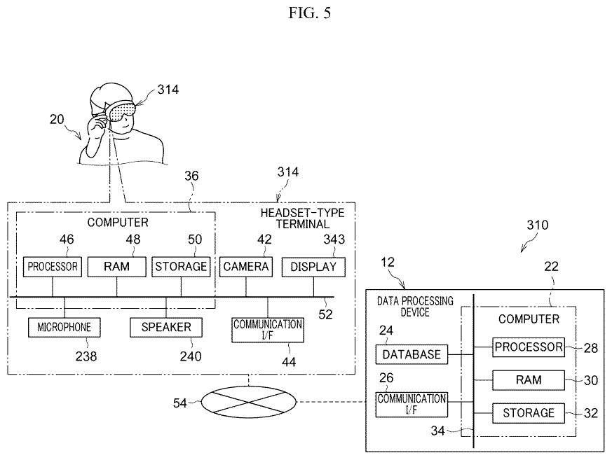

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

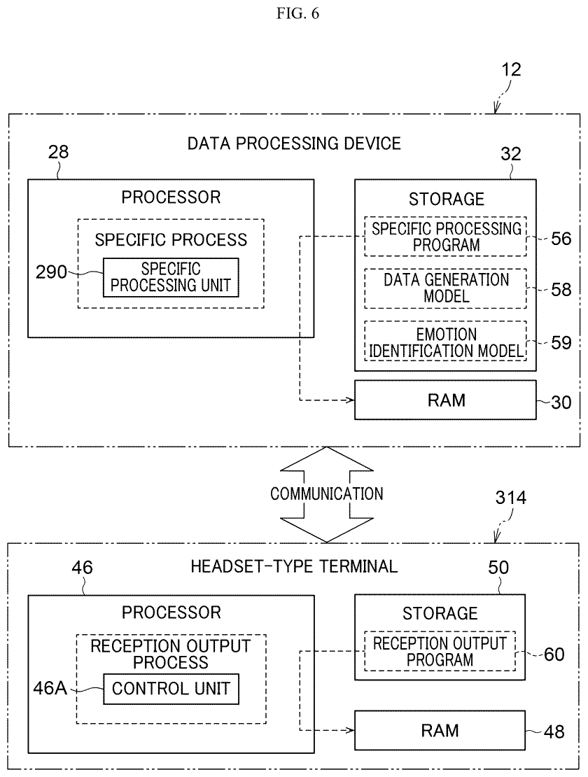

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naive Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

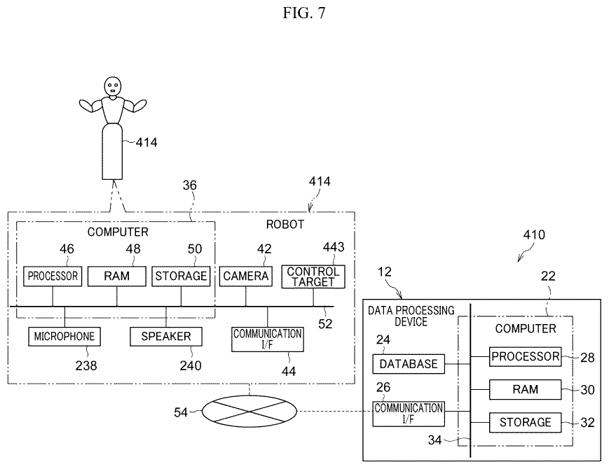

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

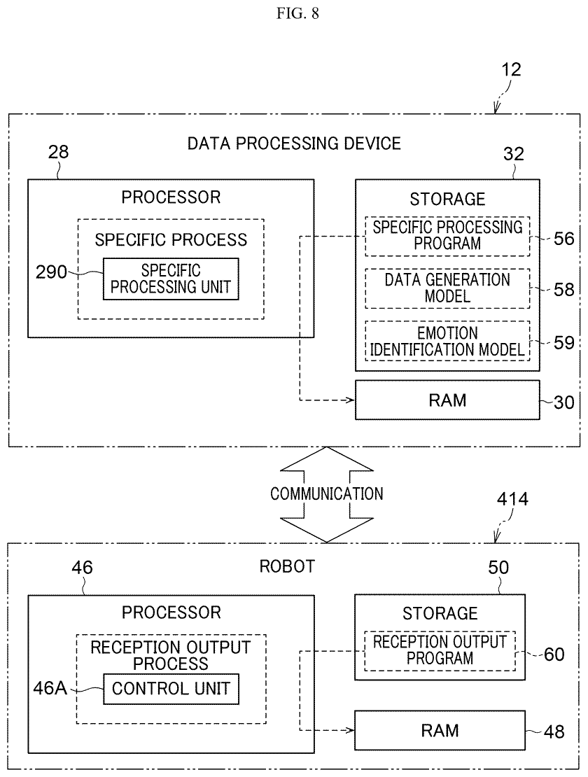

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https: //openai. com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naive Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

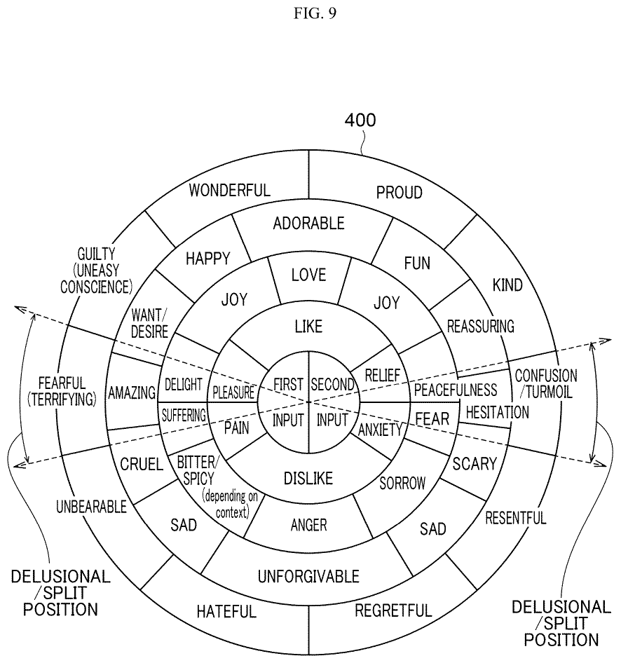

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

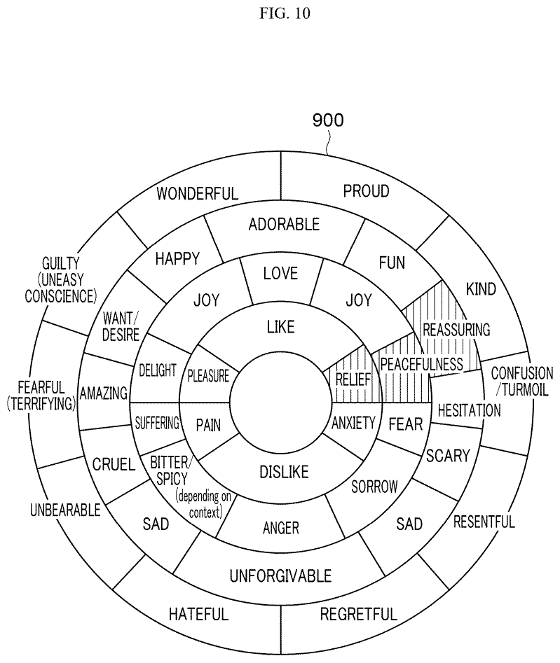

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### (Supplementary 1)

A system comprising a processor,
wherein the processor is configured to
receive, via a terminal and through a communication network, information in a bullet-point format from a user, store the information in a data structure, and acquire the information as input data (input means),
analyze, by using a natural language processing technique, meanings and mutual relationships of phrases included in the information in the bullet-point format acquired by the input means, determine a type, constituent elements, and logical structure of a business document, concatenate the information in the bullet-point format with a template instruction text to generate a prompt sentence as generation instruction information, and generate generation request data including the prompt sentence (prompt generation means),
transmit the generation request data generated by the prompt generation means to an external generative information processing apparatus, and receive business document data obtained by an inference process performed by a generative AI model executed in the external generative information processing apparatus (generation cooperation means),
analyze, by using a character string analysis algorithm and language rule data, the business document data obtained by the generation cooperation means to detect typographical errors and grammatical errors, generate correction proposals automatically, and reflect the correction proposals in the business document data (document verification means),
analyze emotion estimation information including operation history information of the user and expression selection information acquired by the input means, estimate an emotional state of the user, determine adjustment conditions indicating tone, writing style, and level of detail based on the emotional state and preset conditions of the user, and modify at least one of the prompt sentence and the business document data so as to reflect the adjustment conditions (emotion-linked adjustment means), and
transmit the business document data obtained by the document verification means and the emotion-linked adjustment means to the terminal and provide the business document data as output data in a format displayable by the terminal (output means).

### (Supplementary 2)

The system according to supplementary 1,
wherein the processor is configured to cause the prompt generation means and the emotion-linked adjustment means to refer to evaluation standard information including quality standards, expression standards, and prohibitions set by the user via the terminal, and to change, dynamically and based on the evaluation standard information, contents and structure of the prompt sentence for instructing the generative AI model to check and correct contents of the business document.

### (Supplementary 3)

The system according to supplementary 1,
wherein the processor is configured to cause the emotion-linked adjustment means to analyze behavioral information including input speed, input order, correction frequency, and expression selection patterns of the user to evaluate the emotional state of the user, refer to tone information and writing-style information associated with a result of the evaluation, and generate a prompt sentence for instructing the generative AI model to adjust tone and style of the business document, or to modify wording, politeness expressions, and emphasis degree of the business document data obtained by the generation cooperation means.

### Application Example 1

### (Supplementary 1)

A system comprising a processor,
wherein the processor is configured to
receive, from a user terminal, input information in a structured bullet-point format, analyze the bullet-point format information by using generic natural language processing, and construct instruction information including a prompt sentence that defines generation conditions of a communication document to be delivered to a recipient group, the prompt sentence being configured to be supplied to a generative AI model,
verify a communication document candidate obtained from the generative AI model by using a character string analysis algorithm that detects notation errors and linguistic structure errors, mechanically correct content of the communication document candidate based on a verification result, automatically determine consistency between the communication document candidate and numerical information and period information included in the bullet-point format information, and, when an inconsistency is detected, automatically regenerate at least one of the communication document candidate and the prompt sentence,
refer to quality criteria and expression criteria set by a user, dynamically adjust content of the prompt sentence so that the communication document generated by the generative AI model conforms to the quality criteria and the expression criteria in terms of expression style and content modification, and cause the communication document candidate to be regenerated when necessary,
analyze an emotional state of the user based on biological information or operation history, generate an additional prompt sentence for adjusting tone, writing style, and emphasis portions of the communication document according to the emotional state and attribute information of the recipient group, and supply the additional prompt sentence to the generative AI model to obtain a corrected communication document,
convert the corrected communication document into a message format suitable for a predetermined transmission medium, associate destination identification information with the corrected communication document, and execute distribution processing that automatically transmits the corrected communication document to the recipient group via an electronic communication network, and
store, in a recording medium, the bullet-point format information, each prompt sentence, each communication document candidate obtained from the generative AI model, and a result of the distribution processing in association with one another, and make the stored information available as reference information in subsequent prompt sentence generation processing and communication document correction processing.

### (Supplementary 2)

The system according to supplementary 1,
wherein the processor is configured to automatically change instruction content constituting the prompt sentence in accordance with criterion information including allowable character count, prohibited expressions, mandatory expressions, and brand expression policy set by the user, and, based on the criterion information, control a range, tone, and length of content verification and content correction of the communication document performed by the generative AI model.

### (Supplementary 3)

The system according to supplementary 1,
wherein the processor is configured to generate parameters indicating adjustment content of tone and style of the communication document according to an evaluation result of the emotional state of the user, and embed the parameters into the prompt sentence so as to automatically generate a prompt sentence that controls tone, writing style, and emotional nuance of the communication document output by the generative AI model.

### Example 2

### (Supplementary 1)

A system comprising a processor,
wherein the processor is configured to
receive character information as input, analyze list-format information included in the character information, and generate a prompt sentence that instructs a generative information processing model to generate a communication document based on the list-format information,
call the generative information processing model as an external information processing apparatus based on the prompt sentence and criterion information set by a user, and cause the generative information processing model to generate the communication document from the prompt sentence,
apply a character-string analysis algorithm and a language-structure analysis algorithm to the generated communication document to detect error information and grammatical error information, and automatically correct the communication document based on the error information and the grammatical error information,
acquire emotion information relating to the user and the criterion information set by the user, generate editing instruction information for adjusting tone information and style information of the communication document based on the emotion information and the criterion information, and automatically adjust content of the communication document based on the editing instruction information,
store intermediate information and processing history information corresponding to respective processing stages including a generation process, a confirmation process, a correction process, and an adjustment process of the communication document as recording information, and manage a generation procedure of the communication document in a traceable manner based on the recording information, and
acquire the prompt sentence and the criterion information received from a terminal apparatus and transmit the adjusted communication document to the terminal apparatus.

### (Supplementary 2)

The system according to supplementary 1,
wherein the processor is configured to
store the prompt sentence, the criterion information set by the user, and the communication document output from the generative information processing model in association with each other, and dynamically adjust the prompt sentence for instructing the generative information processing model to confirm and correct content of the communication document based on stored association information.

### (Supplementary 3)

The system according to supplementary 1,
wherein the processor is configured to
evaluate an emotional state of the user based on at least one of operation information of the user, biological measurement information acquired from the terminal apparatus, and self-report information input by the user, generate editing instruction information for changing tone information and style information of the communication document in accordance with the emotional state and the criterion information, and generate the prompt sentence including the editing instruction information for the generative information processing model.

### Application Example 2

### (Supplementary 1)

A system comprising a processor,
wherein the processor is configured to
receive information in a bullet-point format as input and analyze the information by using a natural language processing technique to construct a prompt sentence for instructing a generative information processing apparatus to generate business-related information, transmit the constructed prompt sentence to the generative information processing apparatus via a communication function and automatically check the business-related information acquired from the generative information processing apparatus by using a character string analysis algorithm and a syntactic analysis algorithm, and correct typographical errors and grammatical errors in the business-related information,
evaluate an emotional state of a user on the basis of input information acquired from the user or external information by using an emotion analysis function,
generate, on the basis of the evaluated emotional state and criteria preset by the user, a prompt sentence including additional input for adjusting a tone and a style of the business-related information, and instruct the generative information processing apparatus to modify or regenerate contents of the business-related information, and
output the business-related information whose tone and style have been adjusted to a terminal apparatus via the communication function and, in response to a transmission instruction from the terminal apparatus, perform transmission processing of the business-related information by using a transmission control scheme.

### (Supplementary 2)

The system according to supplementary 1,
wherein the processor is configured to
analyze, by using an analysis function, past response history information of a reception target and, on the basis of an analysis result, adjust the prompt sentence so as to optimize structural elements of the business-related information including a subject portion, an introduction portion, and a call-to-action portion.

### (Supplementary 3)

The system according to supplementary 1,
wherein the processor is configured to
acquire editing operation content of the business-related information performed by the user, and, on the basis of the editing operation content, update generation rules for the prompt sentence and weighting conditions of the emotion analysis function so as to adapt business-related information to be generated thereafter to preferences of the user.

What is claimed is:

1. A system comprising:
circuitry configured to:
receive, via a packet-switched network, a collection of list-format data items from a terminal apparatus,
analyze the list-format data items using a natural language processing module to extract semantic representations and determine a document type and a logical structure for a target output,
generate, based on the analysis and a stored template instruction sequence, a composite instruction sequence that combines the list-format data items with generation parameters specifying the document type and the logical structure,
transmit the composite instruction sequence to a generative information processing model and obtain generated document data from the generative information processing model,
apply a character string analysis algorithm and language rule data to the generated document data to detect error information including typographical errors and grammatical errors, and automatically correct the generated document data based on the detected error information, acquire behavioral data associated with user interaction at the terminal apparatus, estimate an emotional state of a user based on the behavioral data using an emotion estimation model, and generate adjustment parameters specifying at least one of a tone attribute and a style attribute based on the estimated emotional state and stored user criteria, and
modify at least one of the composite instruction sequence and the generated document data based on the adjustment parameters to produce adjusted document data, and transmit the adjusted document data as a data packet via the packet-switched network to the terminal apparatus.

2. The system according to claim 1, wherein the circuitry is configured to store the stored user criteria as configuration records including at least one of quality standards, expression standards, and prohibited expression identifiers, and dynamically modify the composite instruction sequence based on the configuration records.

3. The system according to claim 2, wherein the circuitry is configured to modify the composite instruction sequence by inserting constraint tokens specifying at least one of an allowable character count, a mandatory expression, and a brand expression policy derived from the configuration records.

4. The system according to claim 1, wherein the behavioral data includes at least one of input speed measured as keystrokes per unit time, correction frequency measured as text modifications per segment, and expression selection patterns indicating user choices among suggested phrases.

5. The system according to claim 4, wherein the emotion estimation model is a classifier trained on labeled behavioral sequences to output a probability distribution over emotional state categories using a cross-entropy loss function.

6. The system according to claim 1, wherein the circuitry is configured to determine consistency between the generated document data and numerical information and period information included in the list-format data items, and when an inconsistency is detected, regenerate at least one of the generated document data and the composite instruction sequence by re-invoking the generative information processing model with an updated composite instruction sequence.

7. The system according to claim 1, wherein the circuitry is configured to compute vector representations for each of the list-format data items using an embedding model, and determine mutual relationships among the list-format data items based on similarity calculations between the vector representations.

8. The system according to claim 1, wherein the circuitry is configured to store, in association with one another, the list-format data items, each composite instruction sequence, each version of the generated document data, and adjustment parameters applied at each processing stage, and use the stored associated information as reference data for subsequent composite instruction sequence generation.

9. The system according to claim 1, wherein the generative information processing model comprises a transformer architecture including an embedding layer, a plurality of self-attention layers, and an output projection layer, and wherein model parameters have been trained by minimizing a cross-entropy loss between predicted token distributions and target tokens.

10. The system according to claim 1, wherein the circuitry is configured to analyze past response history information associated with a recipient group and adjust the composite instruction sequence to optimize structural elements of the generated document data including a subject portion, an introduction portion, and a call-to-action portion.

11. The system according to claim 1, wherein the circuitry is configured to acquire editing operation data representing modifications applied by the user to the adjusted document data, and update prompt generation rules and weighting conditions of the emotion estimation model based on the editing operation data.

12. The system according to claim 1, wherein the circuitry is configured to convert the adjusted document data into a message format compatible with a predetermined transmission medium, associate destination identification information with the adjusted document data, and execute distribution processing to transmit the adjusted document data to a recipient group via the packet-switched network.

13. The system according to claim 1, wherein analyzing the list-format data items comprises tokenizing each data item, performing part-of-speech tagging and dependency parsing, and classifying the document type using a classifier that receives aggregated embedding vectors as input.

14. The system according to claim 1, wherein the character string analysis algorithm comprises a spelling verification module that compares tokens against a lexicon database using an edit distance algorithm, and a grammar verification module that applies rule-based grammar patterns and a statistical language model to detect linguistic structure errors.

15. The system according to claim 1, wherein modifying the generated document data based on the adjustment parameters comprises applying a rewriting module that replaces expressions in the generated document data with alternative expressions matching a target politeness level and a target formality level specified by the adjustment parameters.

16. The system according to claim 1, wherein the generation parameters included in the composite instruction sequence further specify at least one of a maximum output token count, a sampling temperature value, and a sampling probability threshold for controlling output determinism of the generative information processing model.

17. The system according to claim 1, wherein the emotional state maps to coordinates in an emotion feature space defined by at least a valence dimension and an arousal dimension.

18. A system comprising:
circuitry configured to:
receive, via a packet-switched network, list-format data items from a terminal apparatus, analyze the list-format data items using a natural language processing module and generate a composite instruction sequence combining the list-format data items with a stored template instruction sequence,
transmit the composite instruction sequence to a generative information processing model and obtain generated document data,
apply a character string analysis algorithm and language rule data to detect and correct errors in the generated document data,
determine consistency between the generated document data and numerical information and period information in the list-format data items, and regenerate at least one of the generated document data and the composite instruction sequence when an inconsistency is detected,
estimate an emotional state of a user based on behavioral data from the terminal apparatus, and generate adjustment parameters based on the emotional state and stored user criteria, modify at least one of the composite instruction sequence and the generated document data based on the adjustment parameters,
store the list-format data items, composite instruction sequences, generated document data versions, and adjustment parameters in association with one another as reference data, and transmit adjusted document data as a data packet via the packet-switched network to the terminal apparatus.

19. The system according to claim 18, wherein the circuitry is configured to analyze past response history information associated with a recipient group, adjust the composite instruction sequence to optimize structural elements of the adjusted document data, convert the adjusted document data into a message format, and execute distribution processing to transmit the adjusted document data to the recipient group.

20. A method comprising:
receiving, via a packet-switched network, a collection of list-format data items from a terminal apparatus;
analyzing the list-format data items using a natural language processing module to extract semantic representations and determine a document type and a logical structure;
generating, based on the analysis and a stored template instruction sequence, a composite instruction sequence combining the list-format data items with generation parameters;
transmitting the composite instruction sequence to a generative information processing model and obtaining generated document data;
applying a character string analysis algorithm and language rule data to detect and correct errors in the generated document data;
estimating an emotional state of a user based on behavioral data from the terminal apparatus using an emotion estimation model, and generating adjustment parameters based on the emotional state and stored user criteria;
modifying at least one of the composite instruction sequence and the generated document data based on the adjustment parameters; and
transmitting adjusted document data as a data packet via the packet-switched network to the terminal apparatus.
